(19) United States
(12) Patent Application Publication
(10) Pub. No.: US 2025/0315901 A1
(43) Pub. Date: Oct. 9, 2025

(54) AIR SLEEPER AND INTERNET NETWORK FOR COMMUNITY SOURCED PERSONAL PROTECTION, VIRTUAL VISUALIZATION AND NAVIGATION AND AUTHENTICATING EVIDENCE

(71) Applicant: ARJUNA INDRAESWARAN RAJASINGHAM, Bethesda, MD (US)

(72) Inventor: ARJUNA INDRAESWARAN RAJASINGHAM, Bethesda, MD (US)

(21) Appl. No.: 19/189,201

(22) Filed: Apr. 24, 2025

Related U.S. Application Data
(63) Continuation-in-part of application No. PCT/US2023/077499, filed on Oct. 23, 2023.
(63) Continuation-in-part of application No. 17/322,169, filed on May 17, 2021, now abandoned.
(63) Continuation-in-part of application No. 16/430,061, filed on Jun. 3, 2019, now Pat. No. 11,269,404.
(60) Provisional application No. 63/418,862, filed on Oct. 24, 2022.
(60) Provisional application No. 63/433,468, filed on Dec. 18, 2022.
(60) Provisional application No. 63/463,394, filed on May 2, 2023.
(60) Provisional application No. 63/464,709, filed on May 8, 2023.
(60) Provisional application No. 63/538,267, filed on Sep. 13, 2023.
(60) Provisional application No. 63/545,186, filed on Oct. 22, 2023.

(51) Int. Cl. G06Q 50/00; G06Q 40/04; H04L 9/00; H04L 9/32

(52) U.S. Cl. CPC G06Q 50/01; G06Q 40/04; H04L 9/3297; H04L 9/50

(57) ABSTRACT

A structure and passenger transport paradigm for accommodating passengers in a vehicle with particular attention paid to safety, utility and comfort, social networks including a technology configured to enable community engagement in personal protection and methodologies for virtual visualization and navigation in a remote physical space and provides a mechanism for verification and authentication of video and other evidence.

PRIORITY CLAIMED REFERENCEs: This application claims priority from and incorporates by reference in their entirety the following provisional applications. 63/418,862 filed 2022 Oct. 24; 63/433,468 filed 2022 Dec. 18; 63/463,394 filed 2023 May 2; 63/464,709 filed 2023 May 8; 63/538,267 filed 2023 Sep. 13; 63/545,186 filed 2023 Oct. 22.

### BACKGROUND OF INVENTION

### Field of Invention

The present inventions provide a new structure and passenger transport paradigm for accommodating passengers in a vehicle with particular attention paid to safety, utility and comfort, social networks including a technology configured to enable community engagement inpersonal protection and methodologies for virtual visualization and navigation in a remote physical space and provides a mechanism for verification and authentication of video and other evidence.

### SUMMARY

The Drawings illustrate embodiments of the inventions. These features and more are described below. The invention relates to the referenced filed applications.

### BRIEF DESCRIPTION OF DRAWINGS

23-001—Steps
23-002—Structural plate 3C
23-003—laterally contoured seat back lower section provides lumbar support and also for the lower occupant support, accommodates structural plate 3C
23-004—Sleep space without lateral intrusion using structural plate 3C embodiment
23-005—Shoulder space and arm rest
23-006—Plate 3C
23-007—laterally contoured seat back lower section facilitates angled accommodation with occupant facing the flatbed, and in some embodiments may also provide additional space for the occupant behind.
23-008—Lumbar support that in some embodiments is slidable up and down along the angled surface of the lower seat back, and inflatable for comfort. Shown in a low position
23-009—Flat bed housing with a end cutoff to offer more space to adjoining passenger bed.
23-010—Lowest level of the upper deck for the center aisle on the upper deck. Notably the level of this section can be in some embodiments lower with AirSleepers rather than regular seats.
23-011—intermediate level of the floor of the upper deck that will in some embodiments support the seat section of the AirSleeper.
23-012—High level of the upper deck to support the sleep surface.
22-013—attachment to fuselage wall structure on sides
22-014—stairs to lower deck. Galley may be placed below the stairs
22-015—Seat section of the AirSleeper2.
22-016—Bed section of the AirSleeper 2
22-017—partitions between AirSleeper2 units
22-018—Lower Deck
22-019—Aisle side floor hanger attached to fuselage wall structure at the top.
22-020—Inner side floor hanger attached to fuselage wall structure at the top
22-021—Under seat storage with bin or drawer
24-001—Flip out steps
24-002—Footwell. Some embodiments have contoured foot wells to optimize the foot space for the upper tier and an open visual corridor with minimal obstructions along the axis of the bed for the lower tier.
24-003—Contoured adjustable seat
24-004—Single or double sided video screen upper level (second side will be for the child if child seat is installed.
24-005—Single or double sided video screen Lower level (second side will be for the child if child seat is installed.
24-006—Child seat latch support (one for the several embodiments (optional)
24-007—Headrest
24-008—Spine (some embodiments have tilt able attachment at the seat bottom end to allow reclining) Controls in some embodiments will be attached to the mobile/adjustable seat bottom below arm rest level. Most such embodiments would have such controls on the side of the seat away from the aisle.
24-009—Back rest
24-010—Lumbar Support which can be raised and lowered along the spine and can be inflated or deflated to suit the comfort of the occupant. Inflation in some embodiments are with a manual bellows pump. In others it can be a electric pump. Controls in some embodiments will be attached to the mobile/adjustable seat bottom below arm rest level. Most such embodiments would have such controls on the side of the seat away from the aisle.
24-011—Pivotal support for seat to allow swiveling. Swiveling action may in some embodiments be locked to the axis of the bed or to the axis of the fuselage. Some embodiment have a slid able attachment of the pivot in the direction of the axis of the fuselage to allow people of smaller stature to move forward and those of larger stature to move back. Some of these embodiments have locking mechanisms in 2 or more positions along the slid able axis.
24-012—seat bottom (embodiment shown is a symbolic representation with only the rear portion of the seat, a full seat will be shaped and sized for comfort
24-013—Contoured shape of fixed seatback, including lean-back surface, orthogonal to the axis of the bed that will allow occupant to lounge or recline with feet up on bed surface. This embodiment does not have the contoured adjustable seat but uses the surfaces of the cavity for a seat.
24-014—Cable connecting manual or motorized actuator to the headrest to raise and lower the headrest relative to the spine. Controls in some embodiments will be attached to the mobile/adjustable seat bottom below arm rest level. Most such embodiments would have such controls on the side of the seat away from the aisle.
24-015—Cable connecting manual or motorized actuator to the lumbar support to lower or raise the lumbar support. Controls in some embodiments will be attached to the mobile/adjustable seat bottom below arm rest level. Most such embodiments would have such controls on the side of the seat away from the aisle.
24-016—Spring damper assembly to retract flip outsteps to closed position. Manual operation case for opening stairs. The stairs can also be deployed with a servo. FIGS. 24-014 and 24-015 show the stairs open and fully extended spring damper and also with it partially closed with a partially retracted spring damper. The spring loading will retract the stairs against a damper that will slow the motion. The weight of the passenger and the delay caused but the damper will keep the stairs open and deployed for use.
24-017—Flipoutstairs Step of stairs.
24-018—support flange for steps.
24-019—Stairs support member
24-020—Stair deploy lever.
24-021—Support structure attached to load path for child seat in a position above the flat bed space.>

FIG. 1 and FIG. 2 are of multiple stacked units

FIG. 3 and FIG. 4 are an embodiments of the structure with a flat plate 3 (Plate 3C) which reduces the complexity for manufacture.

FIG. 5 is a single stack structure embodiment which may include the Plate 3C with the wider sleep space and steps.

FIG. 6 is a single stack structure embodiment which may include the Plate 3C, and with the contoured seatback to offer more space for the adjoining bed, and upper seat back with an enclosed space for resting the head and for an arm rest.

FIG. 7 shows an embodiment with a laterally contoured seat, contoured on the aisle side for angled sitting and lumbar support, and laterally contoured on the inner side to accommodate structural plate 3C or other structural members. The contoured lower part of the seat provides lumbar support as well.

FIG. 8 shows the lumbar support in a low position. Some embodiments allow the lumbar support to slide along the surface of the seat back and in some embodiments it is inflatable.

FIG. 9 shows the lumbar support in a high position. Some embodiments allow the lumbar support to slide along the surface of the seat back and in some embodiments it is inflatable.

Some embodiments have sliding arrangements to slide up and down the angled lower surface of the seat back, other have in addition a second sliding arrangement to slide the lumbar support laterally towards the aisle side of the seat to provide support wen the occupant is sitting at an angle with legs up on the flat bed surface.

FIG. 10. Shows the air sleeper architecture with the flat bed housing comprising a cutoff at its end resulting in more space in the high-priority region for the neighboring occupant-in the hip region, while depleting space at the foot and for the passenger using this bed housing.

FIG. 11, 12, 13, 14 refer to AS2 shows a section of the fuselage with the upper deck constructed to optimize vertical space required for both the lower and upper decks. Itis unlike the upper decks of the jumbo aircraft such as the A380 and the B747, in that the floor is not flat across but has several levels based on optimal heights for the two decks. The lower deck requires walking height above the two aisles, and requires adequate space for headroom around the seat or air sleeper configurations on the lower deck. Meanwhile on the upper deck the architecture is organized such that the central aisle serves the seats or air sleepers on either side. The sleep space is high enough to allow for the headroom on the lower deck in the center of the cabin where the center passengers do not need substantial headroom particularly in the case of air sleepers which have a lower height requirement in the center. Similarly, for the seat area on the upper deck which also caters for under seat storage with a bin or a drawer. The headroom here should be adequate for the occupant

on the lower deck to stand up. Finally on the outer ends of the upper deck there is a higher level of the upper deck that is for the sleeper space, which has below it on the lower deck the aisle and assigned seats or air sleepers.

FIG. 15, 16 refer to the AS2 AirSleeper showing the structural support for the upper deck with hangers from the top surface of the fuselage wall structure. Some embodiments of these hangers are constructed to be on the aisle side and the inner side of the seat section of each air sleeper and in some embodiments may be connected along the access of the vehicle to increase the rigidity of these hangers when there is an axial load such as the deceleration of the vehicle. The vertical sections of the floor structure of the upper deck will act as shear planes as they are attached to the inner hangers. Moreover such hangers will have a significant with in the direction of the axis of the vehicle to increase resistance to share loading. This may be an important design consideration considering that the aircraft needs to our certification with a 16 G loading along the axis of the vehicle.

FIG. 17, shows the Defender Internet-based network for vulnerable people.

FIG. 18 shows an emergency mode switch which activates the Emergency Ready state.

FIG. 19 show the Radar feature to notify teams in an emergency alert.

FIG. 20, 21, 22, 23, shows and embodiment of the air sleeper with stairs (24-001) deployed for reaching the upper tier mini suites. It also shows double-sided video screens (single-sided screens are another embodiment) that will have in some embodiments different programming on each of the screens for the adult in the minisuite, and for the child on the other side of the screen, and facing in the opposite direction of the adult. Such an embodiment will reduce weight.

On the upper tier, some embodiments have screen (24-004) supported by the seatback of the mini suite ahead as shown and can be folded to be flush with that seatback.

On the lower tier the screen (24-005) may be folded up towards the ceiling or sideways towards either the foot well of the upper tier or the screen of the adjacent mini suite behind.

The embodiment shown also includes one embodiment of the latch system for the child seat.

The embodiment also shows a foot well for the upper tier mini suite that is contoured to minimize the obstruction of the visual corridor door of the lower tier mini suite along the axis of the flatbed. Such a contour will need to optimize the visual corridor for the lower tier mini suite and the foot space for the upper tier mini suite.

The embodiment also shows a contoured adjustable seat (24-003), which in some embodiments is configured to rotate about a vertical axis approximately in the gluteal region of the occupant. Such payment enables the occupant to swivel from facing forwards along the axis of the cabin,—the utilitarian position for egress and ingress, for meal service, and for working on a desktop with computers and other materials—to a position facing forward along the axis of the flatbed, which is considered to be a comfort position-where the occupant can have his/her legs up on the flatbed to either lounge, recline, to watch a movie on the screens, and in the case of the mini suites on the window side, to look out the window. This will arrangement in some embodiments can be locked in the two positions as noted above. FIG. 24, 25, 26, 27, 28, 30, disclose a embodiment of a single stack of air sleeper mini suites. These figures illustrate an embodiment of the contoured foot well (24-002) in an extreme case of the cutaway to accommodate the visual corridor of the occupant in the lower tier mini suite.

FIG. 24, 25, 26, show the contoured adjustable seat aligned to the axis of the flatbed so that the occupant is facing the visual corridor right up to the end of the flatbed, and in the case of window mini suites, to look out the window. FIG. 27, 28, 30 show the upper mini suite contoured adjustable seat aligned to the axis of the corridor i.e. the usually position, and the lower mini suite contoured adjustable seat aligned to the axis of the flatbed.

FIG. 26 and FIG. 27, 30 also show the support structure 24-021, for a child seat in a position above the sleep space of the flatbed. The structure is attached in this embodiment to the shear plates and the lateral support members

FIG. 29 discloses the contoured adjustable seat. Embodiments of the seat have one or more of a headrest is seatback and lumbar support. The disclosed embodiment has a seat bottom (24-012), with a pivot (24-011), and attached to a spine (24-008) wherein the attachment may be a pivotal attachment controlling tilt of the spine relative to the seat bottom. Such an adjustment may be with a servo motor, or a manual lever. In this embodiment, on the spine is attached a lumbar support (24-010) which in some embodiments has a inflatable feature to increase and decrease the bulk of the lumbar support for the personal preferences of the occupant. Such inflation may be achieved with a pump that is either a manual bellows pump or a electric pump. Controls of an electric pump may be in the vicinity of the armrest of the contoured seat. In addition, the spine has attached to it in this embodiment is seatback (24-009) which again may be adjusted for height by sliding along the spine. Such controls may be manual with levers or with a servo with controls conveniently located in the vicinity of the armrest of the contoured adjustable seat. Moreover, in this embodiment the headrest (24-007) is attached to the spine, and may be slidably attached to move up and down for the comfort of the occupant controls either manual or electric with aservo, with controls located in a convenient location for the occupant as in the case of the seatback and the lumbar support possibly in the vicinity of a armrest of the occupant. FIG. 32 shows an embodiment of the contoured adjustable seat where the height controls for one or more of the lumbar support the seatback and headrest are controlled by cables. Such cables may have their controls in the manual case to a convenient location for occupant control. Alternatively, the vertical adjustment movements of the cables could be actuated. A servo motor in the vicinity of the spine and electric controls provided to the occupant for convenient access.

Some embodiments of the contoured adjustable seat have the pivot 24-011 on the seat bottom 24-012, to be slidable in the direction of the axis of the vehicle or parallel to the Isle. This will accommodate people of larger or smaller stature to get the table feature at a convenient distance. Such assigning arrangement can be manually or electrically actuated. Some embodiments have multiple positions for locking the seat bottom to the loadbearing members of the structure. Lower part for the occupant will pass through the pivotand sliding mechanism, if the seatbelt is mounted on the contoured adjustable seat, and therefore needs to be designed with such loading in mind. An alternative embodiment would have seatbelt attached to the fixed components of the mini suite with direct load paths of the shear plates and/or lateral support members.

FIG. 31 shows an embodiment which does not use a contoured adjustable seat, but rather uses the cavity as shown, with a special feature of having a leaning surface orthogonal to the axis of the flatbed, to facilitate sitting up and leaning back on such are support service while reclining with feet up on the flatbed. FIG. 33 and FIG. 34 discloses an embodiment of the flip up stairs. FIG. 33 shows the stairs deployed. FIG. 34 shows the stairs partially flipped up for storage.

The steps 24-017 are pivotally attached to the support member 24-019 along a horizontal axis. On the other side (the outer side) of the steps is pivotally attached the control lever 24-020. Raising the lever or pulling it towards the support member folds up the stairs. The top end of the control lever is accessible to the occupant in a seated position in the upper tier mini suite. Many other embodiments are possible for control mechanism including servo operated actuation of the steps, with the burden of additional weight.

The stairs are constructed to support the weight of the occupant with one or both of: a tail of the step on the opposite side of the pivot shown protruding into the support member 24-019. In the deployed position the upper surface of the tail contacts the upper surface of an aperture in the support member and thereby provides support for the occupant on the other side of the pivot; a phlange 24-018 which is a part of the support member 24-019 that lies just under the step when deployed, and therefore provides it support when deployed.

The spring damper 24-016 is constructed to keep the stairs in the flipped-up position normally, and is used to control the movement of the stairs when deployed. Some embodiments of the spring damper comprise a spring loading which is tensile and folds up or flips up the steps. Against the force on the lever for deployment or the weight of the occupant the spring is extended. The damper in this embodiment will slow down the rate of closure of the deployed stairs, so that the stairs don't close in the time interval between steps being taken by the occupant while climbing up. Such a damper mechanism who have multistage properties, where the initial folding by a few degrees is very slow to allow the occupant adequate time between steps in what could be a worse case or slow case situation. After that some embodiments can have a second rate of closure by the damper, that is quicker to vacate space in the aisle as soon as possible.

FIG. 35 shows the timelines for recorded media.

Here source 1 streams are represented by S110 to S1tF, fortimes to totF. Similarly, source 2 streams are represented by S2m to S21F.

However, User/viewer 1, begins to capture the stream from source S1 at some time U110 (S1), with the parameters of S1 atthattime recorded. Moreover, user 1 terminates the stream from source 1, atU11F (S1), andimmediately commences viewing the stream from source 2 at U110 (S2), where U110 (S2)=U110 (S2). The user/viewer 1 continues to view the stream from source S2 until U11F (S2), which may be before source S2 terminates streaming.

The cryptographic representation of the streams of both S1 and S2 with their digital signatures are created in one embodiment of the invention, and are available for checking the authenticity of copies of these complete video streams. Similarly, cryptographic representation of the received streams to U1 of each of the constituent streams from S1 and S 2, In this embodiment their digital signatures created, for future reference to copies which may be checked by the instant invention for their authenticity.

In this embodiment there is no possibility of verifying that segments of streams from sources S1, S2 are the same as the streams from these two sources received by user U1.

However, if the stream received by user U1 is then reviewed by others and a copy needs to be authenticated that is possible relative to the stream U1 from both S1 and S2.

Another embodiment that allows authentication of streams directly from the sources is described below.

FIG. 36 shows another embodiment of the invention that modularizes each of the source streams S1 and S2, to fixed time length units, and records their cryptographic representation as a digital signature. Therefore, each of the streams have a sequence of digital signatures for each 10 second interval. The time of each interval of 10 seconds is used only as an example, and any suitable timeframe can be used for the units of the modular structure of each of the sources. However, in this embodiment the plurality of source streams have modules of 10 seconds that are synchronized with the start time of the Source stream and at 10 second intervals thereafter until the end of the Source stream. In some embodiments, the beginning and end of each 10 second module coincides for all the streams in the network. However, this need not be the case in other embodiments. In these embodiments, the user's receive the streams from the sources e.g. S1 and S2.

Therefore, they receive one or more of the 10 second modules which must have the same cryptographic representation. There may be a short period of less than 10 seconds where the user U1 for example, is receiving a stream ahead of synchronized beginning of the next streamed 10 second module. Moreover, the user U1 may terminate his/her reception of the source ahead of the end of the then current 10 second module. With the exception of these periods both before the commencement of the first complete 10 second module that is received and after the last complete 10 second module until termination of the stream, on the other 10 second module digital signatures must be identical to the of the respective sources. Therefore, this embodiment, while it does not capture the digital signatures of the leading few seconds before the first and second module and that of the period Trailing the last 10 second module, has a unique property that the user U1 stream inputs have the same digital signatures as the sources. Moreover, this is true for a sequence of sources that are streamed by the user U1, when each of the streams have the digital signatures of each of the modules of the plurality of streams.

In this embodiment, itis possible to trace back the digital signatures of the modules received by the user to the digital signatures of those streamed by the source. These two (identical) digital signature references being used thereafter to verify purported copies of the video streams of the user using the cryptographic digital signatures.

In some embodiments, the digital signatures of each of the clips tokenizes the clips as assets that can be traded. The source would be the issuer of the tokens, and they will be registered in the wallet of the source. Thereafter, they are tradable. For example, in some embodiments streaming of the clip to a user could require a payment from the user to the source. Such embodiments, can use smart contracts to execute the financial transaction at the time the tokenized clip is transferred from the source to the user. Moreover, such a payment could be for what is effectively a license for use by the user, and may restrict further distribution by the user in some embodiments.

### The Transaction Structure—Element of Block in Block Chain

There are many elements that can be inserted as transactions into each block. These can include the actual times of commencement and end of a stream received by user. They can also include the digital signatures and the identifying source and viewer IDs and the start time of the modules. There can be many of these modules and therefore many of these transactions for a single streaming session.

### Transaction Element Examples:

Source ID
Viewer ID
Stream Commencement time
Stream End Time
Stream Digital Signature -Video

Source ID
Viewer ID
Module start time
Module Digital Signature -Video

Source ID
Viewer ID
module start time
Module Digital Signature -return
Voice channel

The structure of the video stream may have included in its metadata the location of the source. This will of course be part of the data that will be represented by the cryptographic digital signature. In an alternative embodiment the location information at each point in time (at any time interval but most conveniently at the beginning of each module) may be separately provided as a data point in the transaction structure. In one such case, we have the related transaction as:

Source ID
Viewer ID
Latitude
Longitude
Elevation
Module start time
Module Digital Signature

Other examples of such additional information which may be separately inserted into the transaction or made a part of the metadata of the video stream are for example the facing direction of the camera, the field of view and other parameters related to the camera.

In constructing the block from such transactions, we will have multiple transactions as above, a block number, a nonce in the hash of the previous block. All this will be hashed to represent the instant block. In other embodiments the video file in it's raw form will be directly used rather than it's digital signature as noted above as an element of the transaction and in turn of the block to be hashed.

FIG. 38 is an embodiment of the Block in the Block chains. Notably there can be many types of transactions of which one is shown.

FIG. 37, shows the application in a multi-participant videoconference. Here, each of the sources stream their videos to each of the other parties and each of the streams will be cryptographically signed and available for the users for verification of their recordings.

In applications where the sources are distinct from the users the same process would apply but there will be fewer interconnections and necessary videos for cryptographic verification.

In some embodiments, the source streams are maintained as recordings, and pointers on those source recordings at the times of commencement and ending of user access to those recordings are maintained as pointers (See FIG. 39). Therefore, in such embodiments, the source recording is split into modules as before in some of the prior embodiments, and each of those modules is hashed to get a digital signature which can serve as a token. In the event of the source activating the cryptographic/block chain feature at the time of commencement of the stream by the source, in some embodiments the modules will begin at the time of commencement of the source stream, and successive modules will commence at fixed time periods after that commencement. The start time of the source recording is of course recorded, so that the commencement time of each module is known. Each of the clips are in this embodiment hashed and stored for use in assembling the blocks for subsequent admission to the block chain.

In some situations however, the source may not activate the block chain/cryptographic feature. In such an instance, the user is enabled to activate this feature and commence the modularization of the source stream recording from the time of the commencement of the stream to the first user. In terms of storage of the source recording while the entire source recording may be retroactively divided into modules and hashed and stored as separate modules, other embodiments will split the source recording into two parts, the first being up to the commencement of the first user sharing time, and the remainder of the source stream recording which is split into modules and hashed for inclusion into blocks immediately upon the availability. In some instances the Source may not even record the stream ahead of the first User request for cryptographic verification. In such instances there is no record of course ahead of the first request for the cryptographic record by a user.

In these embodiments, the user commencement time pointer and the ending time pointer are maintained in the records, such that the modules required to reconstruct any one of the user streams will be known. In some instances, where the commencement of the first module of the source was at the time of commencement of the source stream, there may not be in alignment in time of the commencement of any one of the user streams and the start/end of modules. Therefore two possible embodiments are possible, where the users stream is augmented to include the sections of the stream that either precede or follow the user stream to bring it in line with the module termination times. In this embodiment, the user will have slightly more information than what was actually transmitted to that user. In an alternative embodiment, the module endpoints closes to the start and the end of the users stream, and lying within the user stream are used as the endpoints for the collection of modules representing the users stream, and used for hashing and as input for the blocks in the Block chains.

Some embodiments of the system do not have a facility for downloading the streams to the user, but rather allow access to the user for viewing their recordings within the system. Other embodiments, allow the user to download the streams that they have selected and watched. In such embodiments, they will be presented with the modules and their respective hashes, or in other embodiments, users are represented with their entire recordings, with additional information on the commencement of each module, the module duration, and the hashes for each of the modules. This will enable the user to reconstruct precisely the clips that constitute each of the modules and their respective hashes. In both these embodiments the user will have access to the hashes of each of the modules and the contents of the modules and can therefore use these tokenized modules for trading value with these downloaded streams.

In other embodiments where such downloads are possible, each of the segments of the stream provided by the source to each one of the users, can be in their entirety be hashed and become tokenized. However this is far less efficient as some segments of the source recording will have multiple users but in this instance, each of those instances will need to have a separate hash which is more computationally intensive. Moreover, the time of availability of the entire user stream recording will delay the time when it's hash can be inserted into a transaction into a block and entered into the block chain.

FIG. 40—Video/Image retrieval from Time machine Map using radar and time/date selection.

FIG. 41 Video/Image retrieval from Time machine Map using radar and time/date selection. “B”NFT selection.

FIG. 42—Video/Image retrieval from Time machine Map using radar and time/date selection. “B”NFT payment.

FIG. 43—Video access with “B” NFT.

FIG. 44—Video/Image retrieval from Time machine Map using radar and time/date selection. “C” NFT

FIG. 45—Video/Image retrieval from Time machine Map using radar and time/date selection. “B” NFT selection.

FIG. 46—Some embodiments have a disclosure of the video only with the “B”NFT and then the option of verification with the “C” NFT along with Block information.

FIG. 47—Diagram of information flows for construction of the transaction data for submitting to block. Some embodiments may use secondary chains as well for efficiency in which case only summary hashes will be on the main chain.

FIG. 48—Show the information flows at the time the “C” NFT is purchased.

FIG. 49—This figure show the ZKP (Zero Knowledge Proof required to bolster the trust of the purchase of the “C” NFT.

FIG. 50—Shows encryption of the final video/evidence data sent to the User for additional security.

In FIG. 42, other embodiments may have a ask price quoted and the user is invited to offer a bid price. Here, a market clearing algorithm will select the best licensee option if licenses are to be restricted. In some embodiments there is no issue of an NFT at all but in traditional fashion, simply provide the asset with an access license.

In FIG. 43, video available for viewing and in some embodiments downloading. Some embodiments have watermark on video and have a second priced phase where the user can pay additional fee for downloading the video.

In FIG. 45 the “C” NFT has attributes of the “B” NFT but in addition includes the right to query for block position and verify the asset at that block position. In some embodiments, asset saved location as referenced on the block transaction is encrypted and is accessed with private keys and therefore such verification is not available to the public who have access to the block chain information alone.

Some of such embodiments may use the private key of one or more custodians of the video network and/or the private key of the Source that generated the data. The encryption in some embodiments will be with the Source Private key and Network Admin Public key.

In FIG. 45, 46, there is a cost of verification. This can be priced as a single charge per user as a persistent access C NFT, or priced on a per verification basis or repurchase of a “C” NFT as a per use access NFT. In FIG. 47, Video (or image or evidence documents or other asset) are saved in the indelible storage facility such as IPFS. Itis assigned a URL cp in the IPFS system. An IPFS CID hashμ is made available for reference to the IPFS URL address for access to the asset such as the video. This hash μ is Encrypted using the Source Private key and the Video Network Public key to create the encrypted CID hash μencrypted.

μencrypted is on the transaction record. The Video Network Private Key will be needed for decryption later. In addition Meta data such as location, time and other parameters of the record may be included.

In addition in some embodiments, a Signature for verification of the creating Source of the video or evidence is constructed with the Source Private Key and μencrypted.

The Source Public Key is also made available to the Video Network eg Wiink!.

In FIG. 48, shows the information flows when the “C” NFT is purchased.

First, the μencrypted is decrypted using the Video Network eg Wiink! Private key. This may be in some embodiments be done in a Video Network Server to maintain confidentiality of μ. The Internal Video Network Server queries IPFS to get the Asset such as the video and Serves that content to the User. The Block information is also available to the User as this is public information but in addition it may be curated by the Video Network Server to present in formation in a better format.

In addition in some embodiments, there is a Signature Verification that can be activated with the Source Public Key that is maintained by the Video Network/Wiink! and made avialbe to the purchaser of the “C” NFT, to verify that the μencrypted did in fact come from the Source.

Considering that the time and location (in the case of evidence not location but characterizing key words) are on the block chain, Users can find the information directly on the block chain.

In FIG. 49, in some embodiments, ZKP (Zero Knowledge proof techniques well known in the background art are used to demonstrate to the user that the video served up by the Video Network/Wiink! server is in fact the video stored at the address cp in IPFS, and the was derived from the CID μ, which was decrypted from μencrypted, without revealing <p, or μ to the buyer of the “C”NFT. Some examples of possible ZKP systems are ZK-STARKs and ZK-SNARKS.

FIG. 50, shows additional encryption of the final evidence or video asset thatis made available to the “C” NFT purchaser for addition security. The Video Network Server will require the Public key of the “C” NFT purchaser to make this possible.

### DETAILED DESCRIPTION OF INVENTION

### AirSleeper

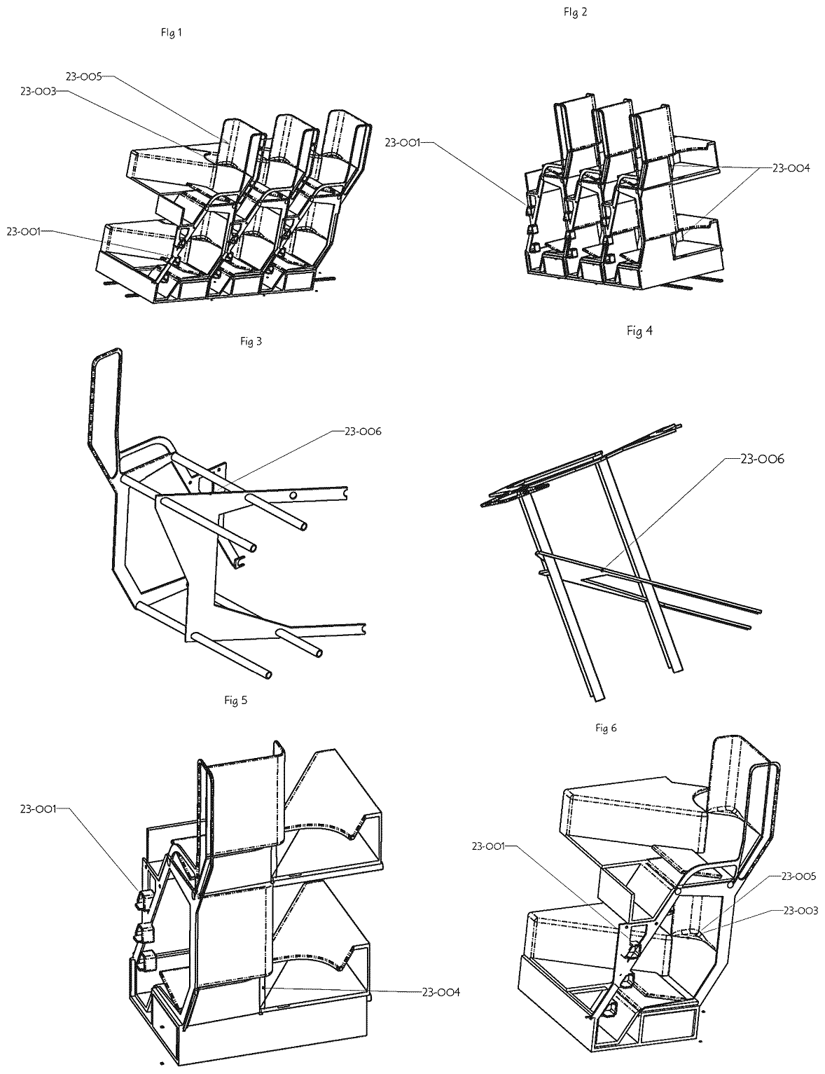

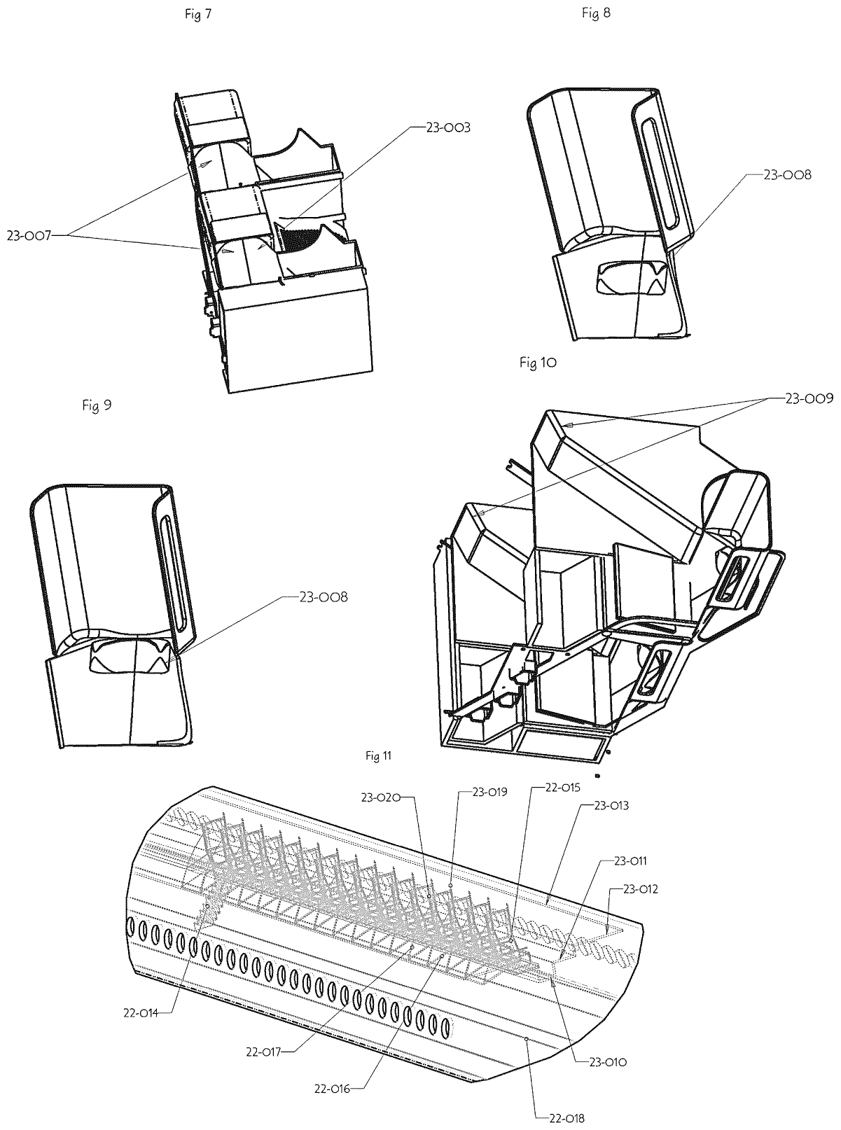

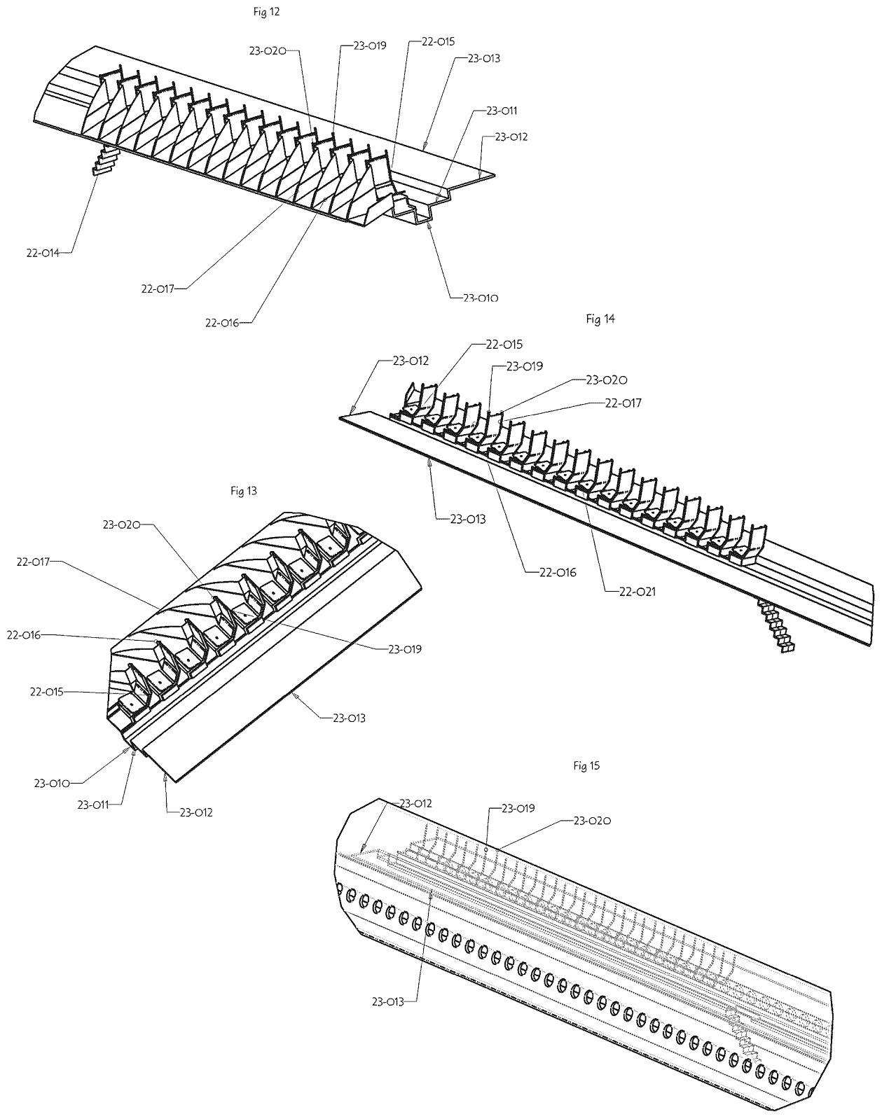

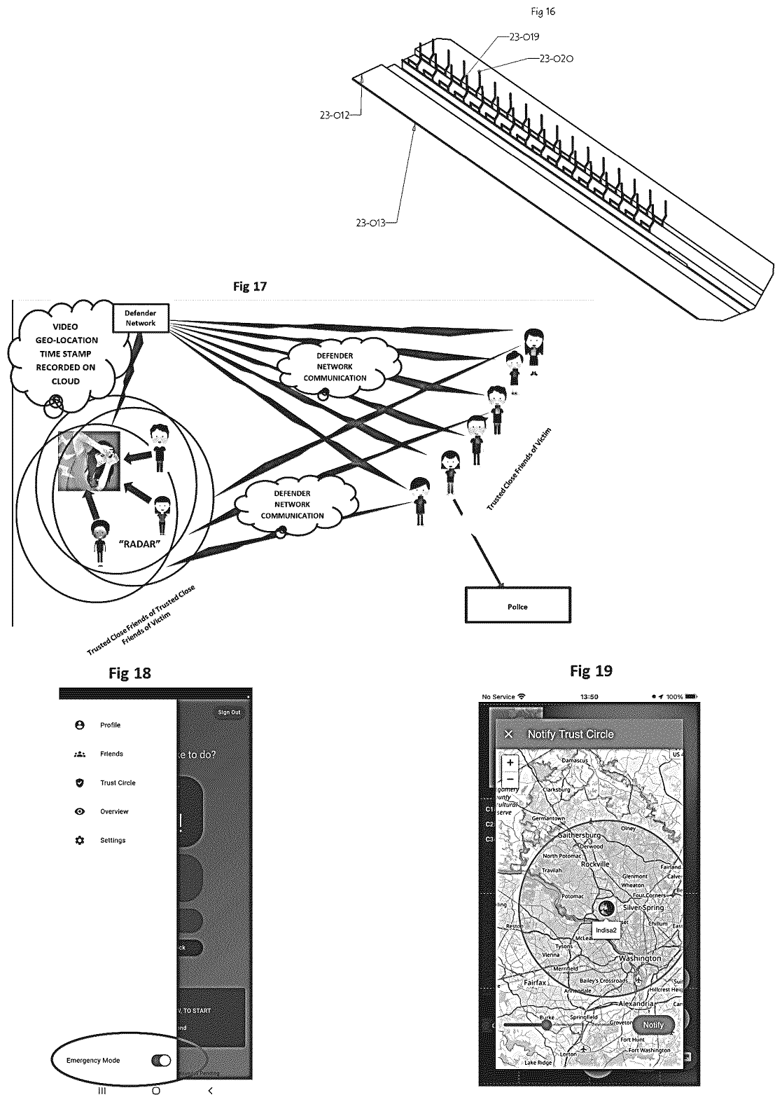

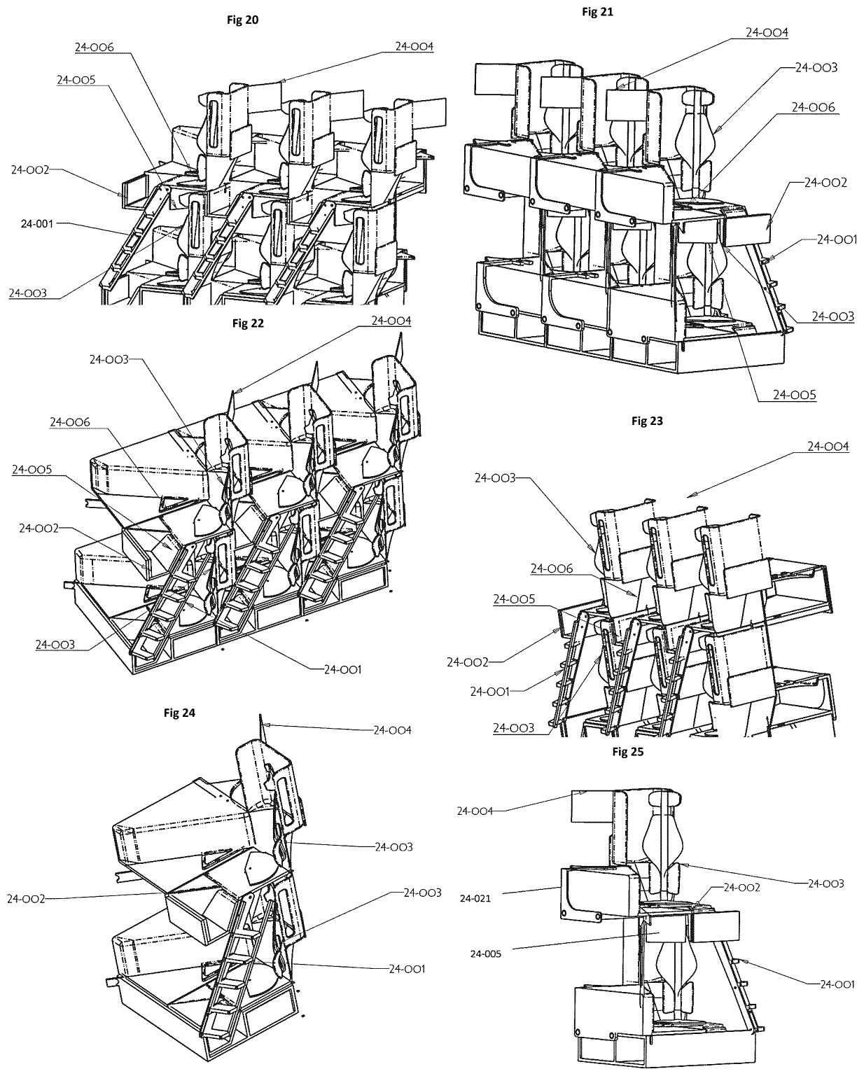

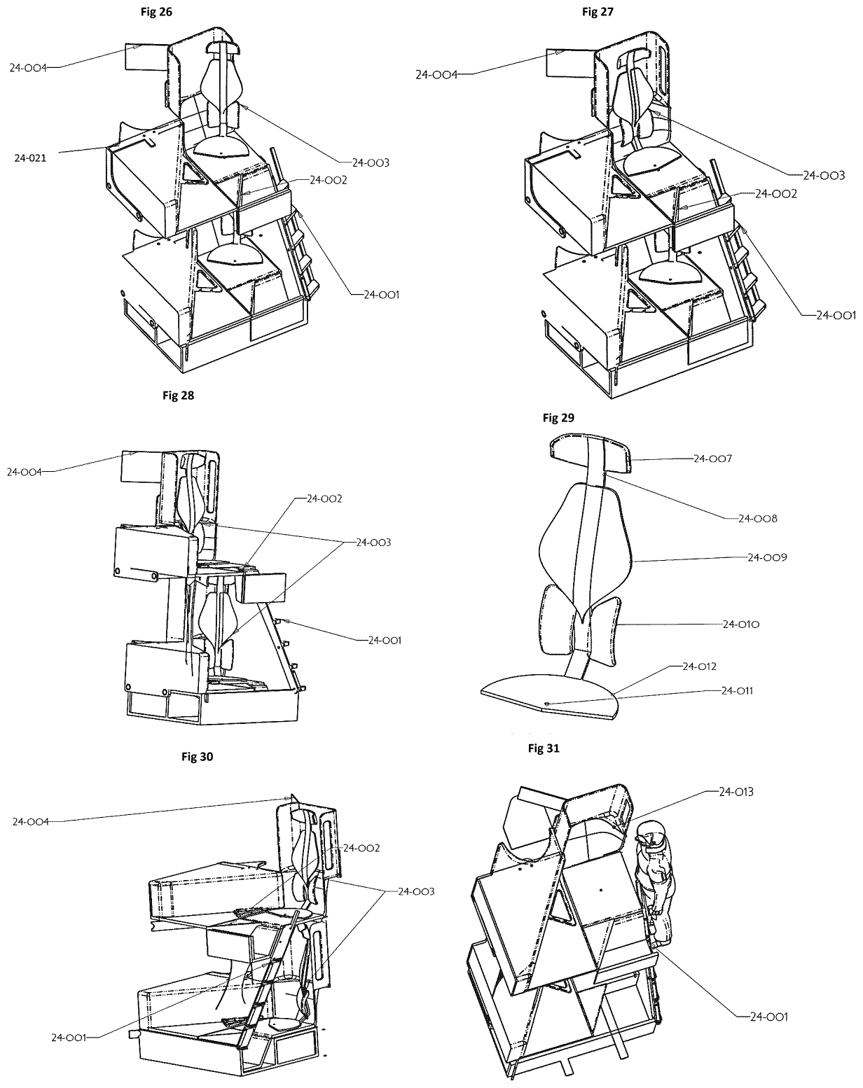

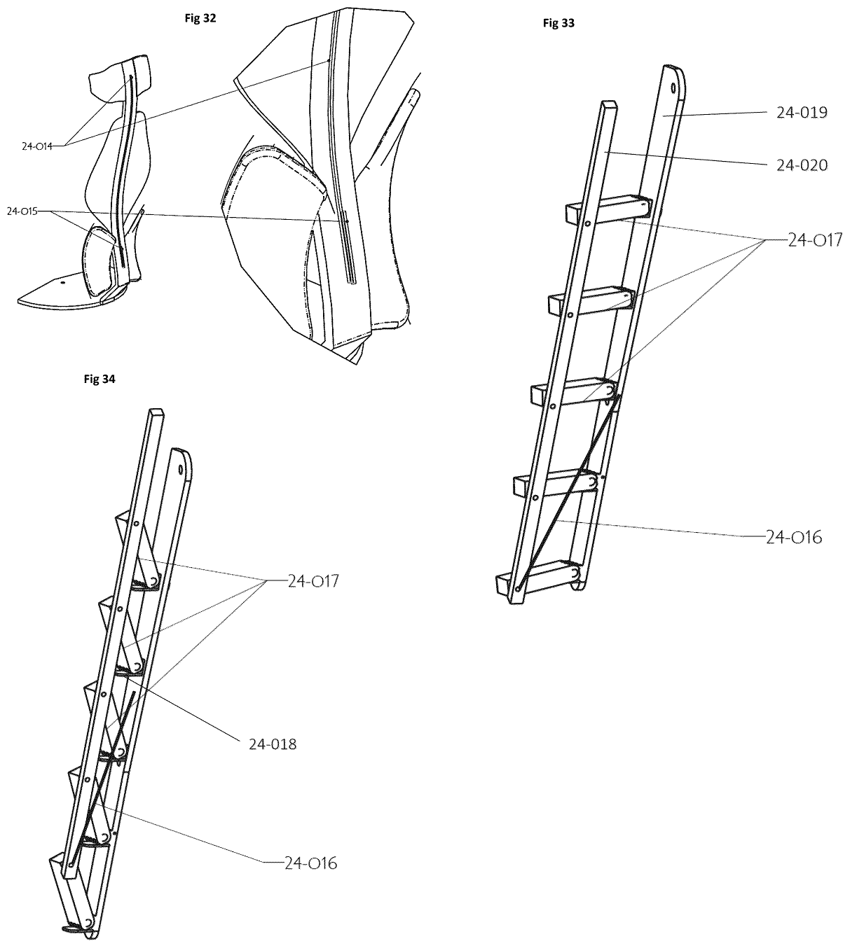

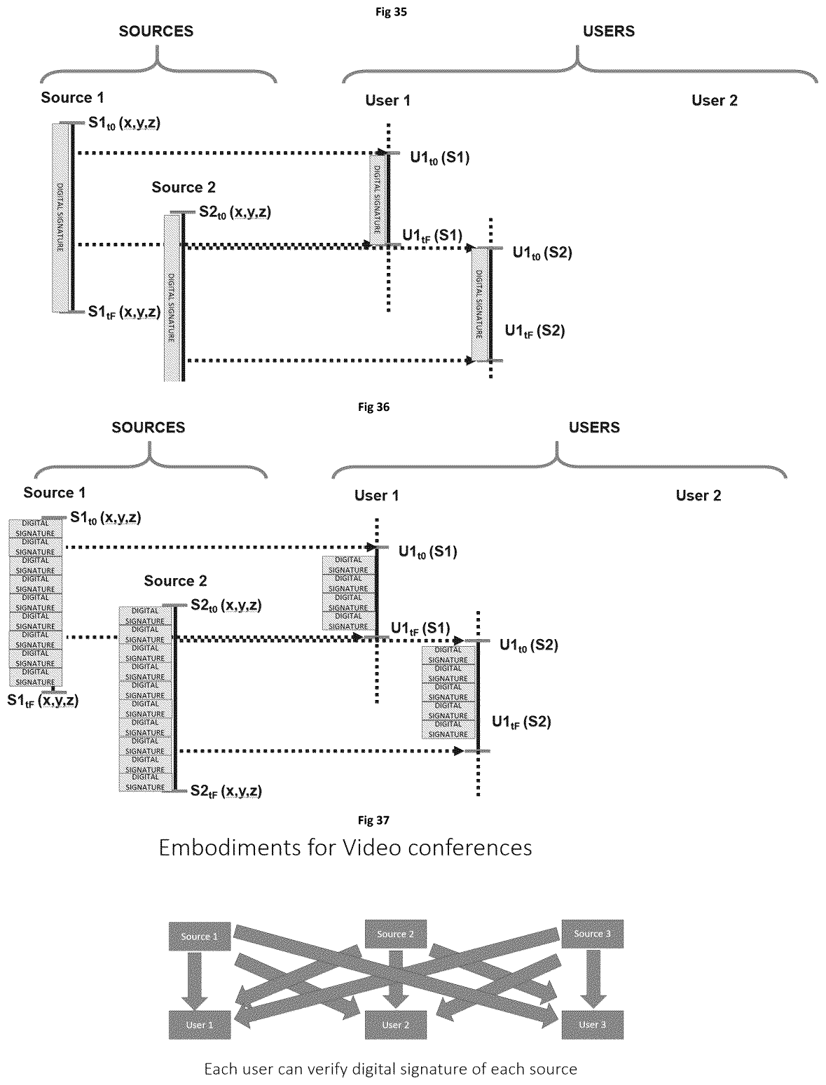

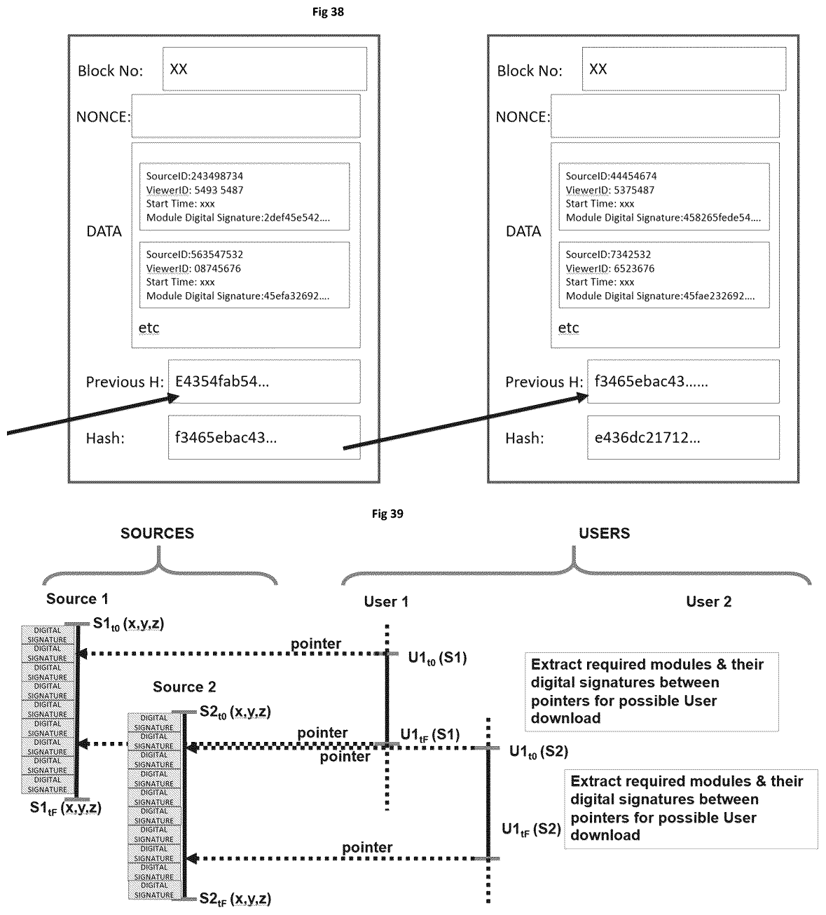

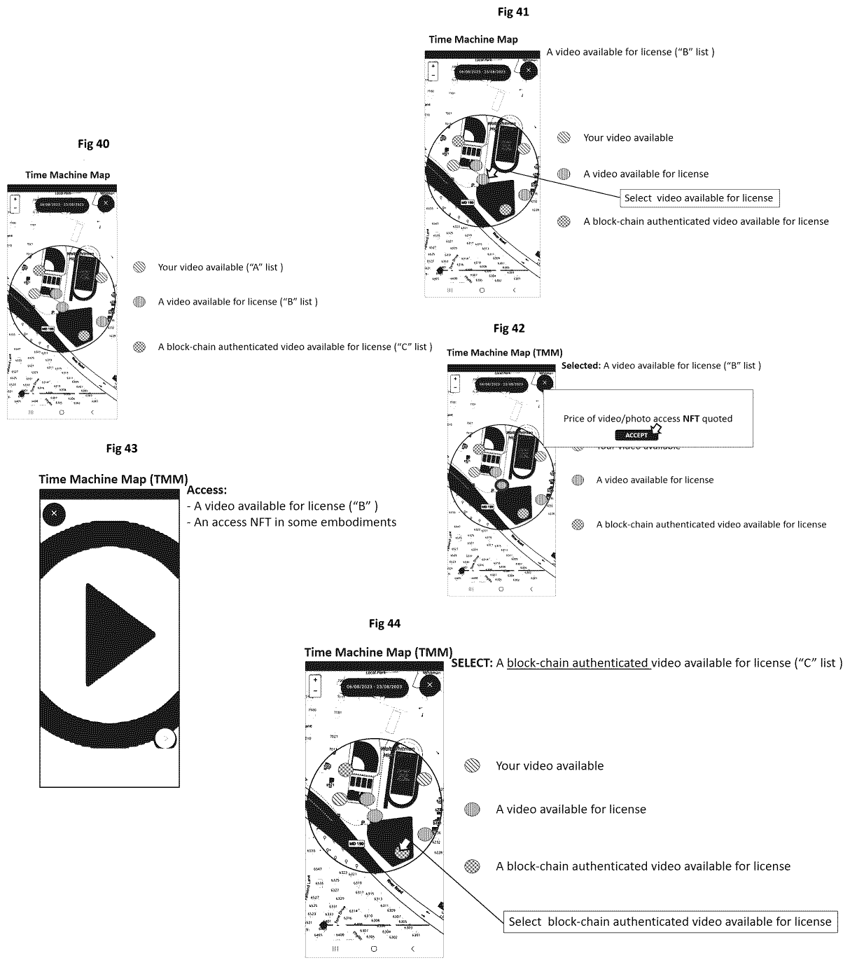

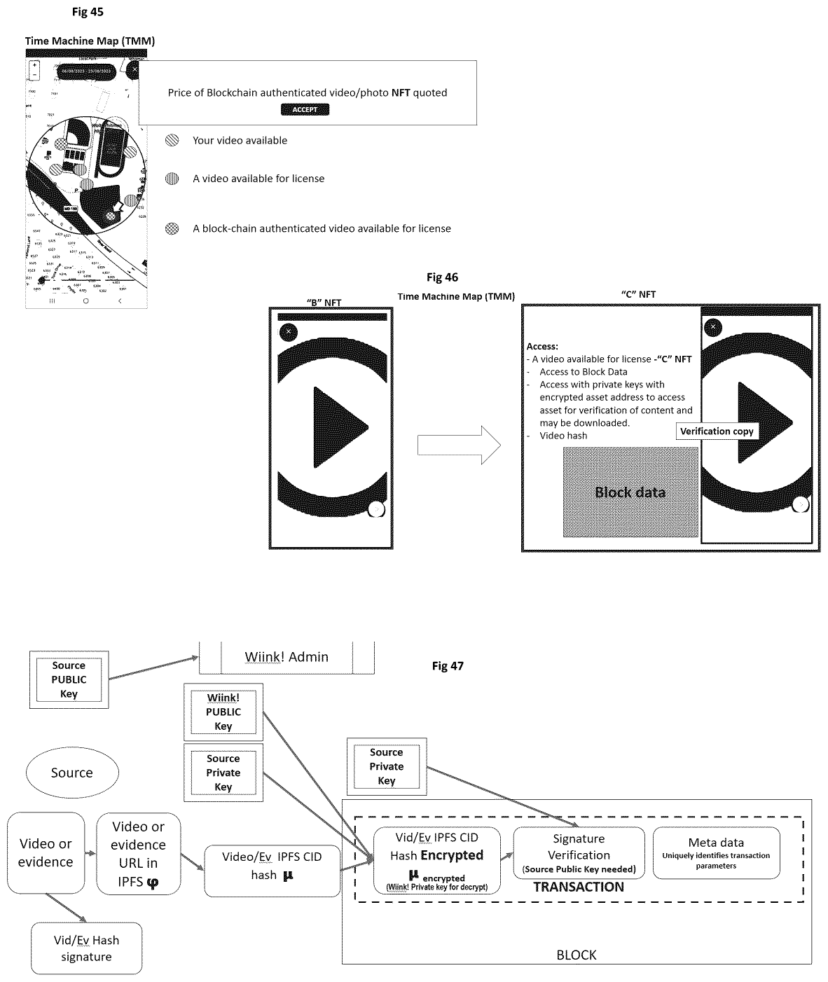

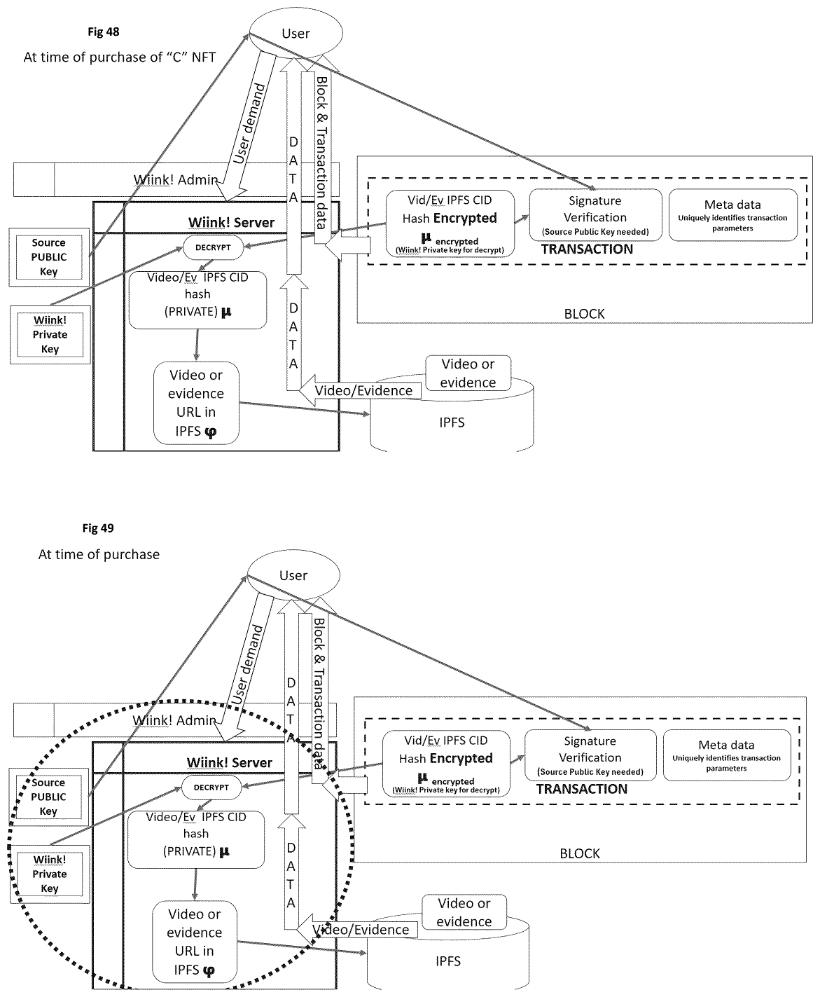

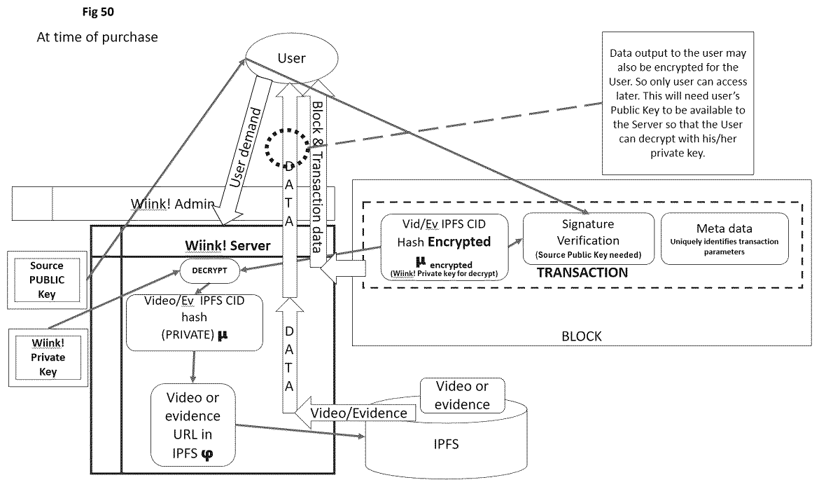

As shown in the figures the airsleeper needs egress and ingress for the upper tier occupants. The embodiment shown in FIGS. 1 and 23-2, provide such egress and ingress access steps that are positioned under the foot space of the upper tier occupant. There positioned in such a way as to minimize obstruction of egress and ingress of the lower tier occupants.

Structurally, the air sleeper requires bracing with one or more shear planes to provide rigidity to the structure in the event of rapid deceleration of the vehicle. Additional embodiments of such a shear plane, are disclosed namely structural plate 3C. In this embodiment of the angled shear plane does not have a section adjoining the lateral tubes, configured to be orthogonal to the lateral tubes. This makes the construction of the structural assembly lower cost and also possibly lower weight. In addition, such a construction of the structural plate 3C, does not intrude into the sleep space of the adjoining bed of the occupant.

The embodiment shown include a version of the seat structure that has a contoured lumbar support that also becomes an adaptation that aligns to the plate 3C. Some embodiments by symmetry and for enhancing the lumbar support will have a similar contour on the aisle side of the seat. As may be seen from the figures such an arrangement widens a narrow point in the bed providing greater utility for the occupant in a sleeping position. Moreover, the lumbar support adaptation of the seat can also provide more space for the occupant behind the seat.

The upper part of the seatbacks may be controlled on one or both sides to offer space for armrests and also for head support in the event the occupant wishes to rest with their heads against the side supports. Itis particularly useful for setting up aligned to the bed.

Furthermore, to enhance the performance of the lumbar support and to allow adjustment of the height and position both vertically and laterally, and added lumbar support 23-003 is installing in some embodiments. This not only allows adjustment for people of different height, but also allows a sitting position that is angled to the axis of the aircraft and pointing substantially in the direction of the bed. The back support contour supports the occupant in such positions. Sliding arrangements for such elements will disclose the background art and could include frictional loading to avoid unintentional displacement. Movement of the lumbar support 23 003 may be manual or be automated with actuators.

A particular consideration for the air sleeper, is that the bed with at its narrowest point should be maximized. Some embodiments, with this consideration in mind may have a contour of the flat bed housing with an end cutoff to offer more space to the adjoining passenger bed. This may be seen in FIG. 10.

### AirSleeper2

FIG. 11, 12, 13, 14 refer to AS2 shows a section of the fuselage with the upper deck constructed to optimize vertical space required for both the lower and upper decks. Itis unlike the upper decks of the jumbo aircraft such as the A380 and the B747, in that the flow is not flat across but has several levels based on optimal heights for the two decks. The lower deck requires walking height above the two aisles, and requires adequate space for headroom around the seat or air sleeper configurations on the lower deck. Meanwhile on the upper deck the architecture is organized such that the central aisle serves the seats or air sleepers on either side. The sleep space is high enough to allow for the headroom on the lower deck in the center of the cabin where the center passengers do not need substantial headroom particularly in the case of air sleepers which have a lower height requirement in the center. Similarly, for the seat area on the upper deck which also caters for under seat storage with a bin or a drawer. The headroom here should be adequate for the occupant on the lower deck to stand up. Finally on the outer ends of the upper deck there is a higher level of the upper deck that is for the sleeper space, which has below it on the lower deck the aisle and assigned seats or air sleepers. The air sleepers shown in the figures offer a 30 inch wide bed and a 24 inch wide seat, all within a 36 inch pitch. This architecture is visualized in the 787 Dreamliner.

Multiple versions of the AirSleeper previously disclosed can be used to populate the upper and/or the lower decks.

FIG. 15, 16 refer to the AS2 AirSleeper showing the structural support for the upper deck with hangers from the top surface of the fuselage wall structure. Some embodiments of these hangers are constructed to be on the aisle side and the inner side of the seat section of each air sleeper and in some embodiments may be connected along the access of the vehicle to increase the rigidity of these hangers when there is an axial load such as the deceleration of the vehicle. The vertical sections of the floor structure of the upper deck will act as shear planes as they are attached to the inner hangers. Moreover such hangers will have a significant with in the direction of the axis of the vehicle to increase resistance to share loading. This may be an important design consideration considering that the aircraft needs to our certification with a 16 G loading along the axis of the vehicle. Such considerations will supplement the role of the floor as a shear plane to support loading in the axial direction of the vehicle under severe deceleration.

### Internet Based Network for Community Engagement for Protection of the Vulnerable.

The problem: for reasons of gender, minority status with regard to religion, ethnicity or caste/class, individuals may be vulnerable to physical attack when in physically isolated environments. In many societies, police intervention may not be realistic particularly in lawless societies and for disadvantaged communities around the world. Therefore, as a result there is an urgent global need for alternatives for defending these vulnerable people in such situations. Moreover, there is a need to inform watchdog organizations both local and global to recognize abuse and promote legislation and advance international norms to address such abuse often not even detected or reported. Moreover, such oversight will be a deterrent to the violence phenomenon. The solution needs to be low cost or better still costless for potential victims.

The technical solution: mobile phones are now ubiquitous and omnipresent the populations around the world. While there are many solutions where the use of mobile phones allows features to alert the authorities, such authorities may not even be available particularly for disadvantaged communities. There is also the possibility of informing the friends of the victim. However, even if such information is provided to friends, there would be no mechanism except with individual telephone calls by the friends to initiate and organize some form of defense. Which means that there is a observation potential and no mechanisms for control of the dangerous violent situation. Therefore, current solutions fall far short of the need as there are no controls possible of the violence or other danger particularly where the timing of a response is critical.

The instant invention constructs a network of trusted friends with known geo-locations in real time, that is available in an emergency for the further construction of a team curated in a specific and particular way from the most likely persons to help, chosen in a way specific to this invention, with the additional requirement of being physically within a specific distance of the victim. These are two specific characteristics and requirements of this invention. Moreover, the invention in some embodiments uses streamed video from the victim's camera and streamed video from one or more members of the team members indexed by their location and available for viewing by any one of the other team members. Selection of any one of the streamed camera views is by tapping/clicking on the icon for the desired team member's view in one or both of the current field of view of the team member and a local map with the team members and victim. The positions of icons in the current field of view of a viewing team member provides “the lay of the land” or obstructions, suitable paths etc for the viewer and in addition indexes and shows the icons of the positions of other members of the team who may be selected as well for their fields of view. Moreover, some embodiments have audio voice channels for conference among the team members to construct collective intelligence both from being able to share the views from any of the team member cameras and benefitting from their pooled insights to track down and apprehend the offender.

In the solution, trust relationships between the trustor and trustee may in some embodiments be directional and in others non-directional. The trustees of any victim are provided information that allows them to make decisions using their own directional trust circle to alert and enable members of their own trust circle located in the vicinity of the victim—the rescuers—to navigate to the location of the victim. In addition the solution in some embodiments has a feature where the rescuers work in a team with the ability to virtually navigate to any one of the camera views of other rescuers, or the victim and place each one of the team in the local 3_0 visual environment so that relative locations are easily internalized with one or both of a map and locations in the real environment identifiable by icons which may be selected to move to those points of view

This technical solution for the noted problem is constructed as a new technology with an Internet based trust network that indexes the locations of the mobile phones (sources) of participating members to the physical locations of those mobile phones, thereby creating a digital twin of the visual space inhabited by the participating members. In this particular case such a space is what is surrounding the victim as the members of the team are chosen to be physically in close proximity to the victim's Geo-Location.

As a first step, a member anticipating transition through a high risk environment enables an emergency mode. Thereafter, in emergency mode, upon activation of an emergency alert, by pressing a designated preprogramed button on the side of the phone, violently shaking the phone for a period of 10 milliseconds or more, by the victim, SOS notifications are sent to each one i of the members TCo(i) of the victim's trust circle (TC₀) such that upon acceptance of the notification by any one of the TCo(i), it enables those members of the victim's trust circle (TCo) that have accepted the notification (the “Level O Team”), to act in a unique and particular way to defend the victim. Upon notification to the i^{th} member of TCo, referenced here as TCo(i), the network offers TCo(i) it immediately streams the camera view of the victim and encourages the Level O Team Member to search for the victim and notify authorities. However, importantly, in some embodiments, that streamed video of the victim includes an overlay with icons on the positions of all the Trust Circle Member of that TCo(i), denoted TC1, that happen to be in that neighborhood. The TCo(i) is enabled to select icons of all those members of his TC1 in that visual neighborhood seen in the streamed video of the victim. In addition in some embodiments, the TCo(i) is presented with a supplementary map (that may be a popup map), with a radar feature that identifies all the members of TC1 within a radar radius that is set for a default value of 500 m but can be modified by the TCo(i). The TCo(i) views the map, sets the radius of the radar and selects notify and the selected members of the TC1 are notified. Those that accept the notification are member of Level 1 Team (i), from the TCo(i)

The Level 1 Team (i) members are immediately presented with the camera stream of the victim and in addition on an overlay of that stream, selectable icons of all the other members of Level 1 Team (i) in the locations of each of those Level 1 Team (i) members. These icons upon selection switch to the videos of the camera streams of the selected Level 1 Team (i) member. Considering that the Level 1 Team (i) members are in the neighborhood of the victim, this selection feature enables each Level 1 Team (i) Member virtually navigate the space and to thereby build a mental 3-0 model of the neighborhood by internalizing the camera streams of the victim and the camera streams of the Level 1 Team (i) Members to enhance intelligence of the Level 1 Team (i) for the task of apprehending the offender.

Some embodiments have in addition an audio conference feature among the Team Members to allow them to strategize the process of apprehending the offender with the knowledge of the 3-D structure of the environment.

Further some embodiments have in addition a map of the neighborhood with the selectable icons of the Level 1 Team (i) Members, so that the members have in addition to the mental image of the 30 space from selecting the icons on the visual image overlays, can also get a sense of the map representation of the layout. Some embodiments may integrate all the Level 1 Team (i) teams for all “i” to a single Level 1 Team. The embodiments shown have a first and second TC teams ie Level O Team and Level 1 Team (i). However, the system can be extended to multiple levels of Trust Circles, where for example the Level 1 Team (i) members are enabled to contact their own Trust Circles and engage their participation with the information infrastructure noted above and iteratively in the higher level teams eg, Level 2 Team (i,j), Level 3 Team (i,j,k), Level N Team (I, j, k, . . . )

Other use cases for the invention are for tactical coordination in a war theater and similar applications.

FIG. 20, 21, 22, 23, shows and embodiment of the air sleeper with stairs (24-001) deployed for reaching the upper tier minisuites. It also shows double-sided video screens (single-sided screens are another embodiment) that will have in some embodiments different programming on each of the screens for the adult in the mini suite, and for the child on the other side of the screen, and facing in the opposite direction of the adult. Such an embodiment will reduce weight.

On the upper tier, some embodiments have screen (24-004) supported by the seatback of the mini suite ahead as shown and can be folded to be flush with that seatback.

On the lower tier the screen (24-005) may be folded up towards the ceiling or sideways towards either the foot well of the upper tier or the screen of the adjacent mini suite behind.

The embodiment shown also includes one embodiment of the latch system for the child seat.

The embodiment also shows a foot well for the upper tier mini suite that is contoured to minimize the obstruction of the visual corridor of the lower tier mini suite along the axis of the flatbed. Such a contour will need to optimize the visual corridor for the lower tier mini suite and the foot space for the upper tier mini suite. The embodiment also shows a contoured adjustable seat (24-003), which in some embodiments is configured to rotate about a vertical axis approximately in the gluteal region of the occupant. Such payment enables the occupant to swivel from facing forwards along the axis of the cabin,—the utilitarian position for egress and ingress, for meal service, and for working on a desktop with computers and other materials—to a position facing forward along the axis of the flatbed, which is considered to be a comfort position—where the occupant can have his/her legs up on the flatbed to either lounge, recline, to watch a movie on the screens, and in the case of the mini suites on the window side, to look out the window. This will arrangement in some embodiments can be locked in the two positions as noted above.

FIG. 24, 06, 07, 08, 09, 11, disclose a embodiment of a single stack of air sleeper mini suites. These figures illustrate an embodiment of the contoured foot well (24-002) in an extreme case of the cutaway to accommodate the visual corridor of the occupant in the lower tier mini suite.

FIG. 24, 06, 07, show the contoured adjustable seat aligned to the axis of the flatbed so that the occupant is facing the visual corridor right up to the end of the flatbed, and in the case of window mini suites, to look out the window. FIG. 27, 09, 11 show the upper mini suite contoured adjustable seat aligned to the axis of the corridor i.e. the usually position, and the lower mini suite contoured adjustable seat aligned to the axis of the flatbed.

FIG. 26 and FIG. 27 also show the support structure 24-021, for a child seat in a position above the sleep space of the flatbed. The structure is attached in this embodiment to the shear plates and the lateral support members

FIG. 29 discloses the contoured adjustable seat. Embodiments of the seat have one or more of a headrest is seatback and lumbar support. The disclosed embodiment has a seat bottom (24-012), with a pivot (24-011), and attached to a spine (24-008) wherein the attachment may be a pivotal attachment controlling tilt of the spine relative to the seat bottom. Such an adjustment may be with a servo motor, or a manual lever. In this embodiment, on the spine is attached a lumbar support (24-010) which in some embodiments has a inflatable feature to increase and decrease the bulk of the lumbar support for the personal preferences of the occupant. Such inflation may be achieved with a pump that is either a manual bellows pump or a electric pump. Controls of an electric pump may be in the vicinity of the armrest of the contoured seat. In addition the spine has attached to it in this embodiment is seatback (24-009) which again may be adjusted for height by sliding along the spine. Such controls may be manual with levers or with a servo with controls conveniently located in the vicinity of the arm rest of the contoured adjustable seat. Moreover, in this embodiment the headrest (24-007) is attached to the spine, and may be slidably attached to move up and down for the comfort of the occupant controls either manual or electric with a servo, with controls located in a convenient location for the occupant as in the case of the seatback and the lumbar support possibly in the vicinity of a armrest of the occupant.

FIG. 32 shows an embodiment of the contoured adjustable seat where the height controls for one or more of the lumbar support the seatback and headrest are controlled by cables. Such cables may have their controls in the manual case to a convenient location for occupant control. Alternatively the vertical adjustment movements of the cables could be actuated. A servo motor in the vicinity of the spine and electric controls provided to the occupant for convenient access.

Some embodiments of the contoured adjustable seat have the pivot 24-011 on the seat bottom 24-012, to be slidable in the direction of the axis of the vehicle or parallel to the Isle. This will accommodate people of larger or smaller stature to get the table feature at convenient distance. Such assigning arrangement can be manually or electrically actuated. Some embodiments have multiple positions for locking the seat bottom to the loadbearing members of the structure. Lower part for the occupant will pass through the pivot and sliding mechanism, if the seatbelt is mounted on the contoured adjustable seat, and therefore needs to be designed with such loading in mind. An alternative embodiment would have seatbelt attached to the fixed components of the mini suite with direct load paths of the shear plates and/or lateral support members.

FIG. 31 shows an embodiment which does not use a contoured adjustable seat, but rather uses the cavity as shown, with a special feature of having a leaning surface orthogonal to the axis of the flatbed, to facilitate sitting up and leaning back on such are support service while reclining with feet up on the flatbed.

FIG. 33 and FIG. 34 discloses an embodiment of the flip up stairs. FIG. 33 shows the stairs deployed. FIG. 34 shows the stairs partially flipped up for storage.

The steps 24-017 are pivotally attached to the support member 24-019 along a horizontal axis. On the other side (the outer side) of the steps is pivotally attached the control lever 24-020. Raising the lever or pulling it towards the support member folds up the stairs. The top end of the control lever is accessible to the occupant in a seated position in the upper tier mini suite. Many other embodiments are possible for control mechanism including servo operated actuation of the steps, with the burden of additional weight.

The stairs are constructed to support the weight of the occupant with one or both of: a tail of the step on the opposite side of the pivot shown protruding into the support member 24-019. In the deployed position the upper surface of the tail contacts the upper surface of an aperture in the support member and thereby provides support for the occupant on the other side of the pivot; a phlange 24-018 which is a part of the support member 24-019 that lies just under the step when deployed, and therefore provides it support when deployed.

The spring damper 24-016 is constructed to keep the stairs in the flipped-up position normally, and is used to control the movement of the stairs when deployed. Some embodiments of the spring damper comprise a spring loading which is tensile and folds up or flips up the steps. Against the force on the lever for deployment or the weight of the occupant the spring is extended. The damper in this embodiment will slow down the rate of closure of the deployed stairs, so that the stairs don't close in the time interval between steps being taken by the occupant while climbing up. Such a damper mechanism who have multistage properties, where the initial folding by a few degrees is very slow to allow the occupant adequate time between steps in what could be a worse case or slow case situation. After that some embodiments can have a second rate of closure by the damper, that is quicker to vacate space in the aisle as soon as possible.

The following description memorializes, extends and provides variations for prior disclosures for example in PCT/US 2021/016293, on the use of block chain technology or more broadly cryptographic technologies for verification and authentication of video data.

The active network of the virtual navigation system may be linked to a block chain network (with nodes) and including the Sources and Users as transactors in the VNS. Therefore, participating Sources and User Members will have their transaction copies on the block chain. The transfer of experience through audio and video communication channels in the VNS system from Sources to Users, however can be replicated to many Users from each Source. Therefore, unlike money transactions as used in for example Bitcoin and Ethereum networks, an experience can be shared with many consumers of the experience—the Users. Unlike a financial transaction, the transaction object structure will contain unique identifying information related to segments of the communication from Source to User (and/or the reverse audio channel if present). As a User navigates from one Source to another he/she leaves footprints of the path from one Source to the next. For each Source therefore, there is a start time and location that defines the beginning of the segment from that Source, and an end time and in location that defines the end of the segment from that Source. Moreover, each of those segments from the Source comprises data and a unique summary representation of the data such as a checksum/hash we characterize the segment. Also the time duration between start and finish of the segment can be computed. Furthermore, the protocol for communication of each segment will be established at the time of communication (for example in web RTC the SOP exchange establishes the common protocol between Source and User interface communication nodes). In some embodiments, the transaction structure in the block chain used to authenticate communications in the VNS may in embodiments contain one of the following sets of information or variations thereof, in addition to the standard elements of transaction objects (eg in Ethereum: Nonsc, to, gasprice, gas limit, v,r.s):
1. The start time and location, end time and location, checksum/hash of segment between start time and end time, protocol for communication,
2. The start time and location, end time and location, checksum/hash of segment between start time and end time.
3. The end time and location, duration of segment, checksum/hash of segment between start time and end time.

One or more of such transactions are included in a Block. Notably the systems and units of each of the parameters above must be predefined.

An alternative in some embodiments would define transactions with synchronous event capture in fixed periods-say every minute with location and time records and checksums for the period, rather than using the start time and in time with locations. Depending on the size of the network, there may be challenges in the number of transactions and an unreasonably large Block Time constructing and maintaining the block chain. Notably, with a view to authentication a Source can also be a User, and therefore, record segments for self-consumption with the block chain activated for authentication.

Considering that there is a cost in using the block chain, Users may opt to engage the block chain or not depending on their interest in authentication of the shared information in any segment, and in some cases required payments for tokenized transfer of video information.

Each block of the block chain, will include multiple transactions some of which will include the cryptographic signature hash or token that is generated along with the identities of the transactors (in this example the Source and the Viewer) and the time and other relevant parameters as required that define the transaction along with a block number and a nonce. It will also include the hash from the previous block. This data is then hashed to give the hash of the block for use in the next block. See FIG. 38.

Video content (and in some embodiments the audio back channel as well), in some embodiments as hashed/check summed to create a token using a protocol as defined herein, so that the recording of streamed video can be verified with the same process for digital signature creation of the received stream and compared for authenticity. This activation with the BlockChain network, can be achieved at the User interface communications node which is a client on the active network with the block chain network, with client commands programmed to instruct activating or deactivating the block chain for the current segment. (The blockchain applications for smart contracts may in some embodiments for example be programmed for Ethereum in Solidity with an API for a node.js application and use web3.js libraries to interact with the block chain).

Payment for tokens with the use of the block chain for any segment can utilize the standard approaches for payment such as in Ethereum. Users and Sources have wallets and the Blockchain will in some embodiments include financial transactions. Moreover, if there is future value in a segment from a Source, Users may wish to pay a price to receive that segment. This price can be set by the Source. The payment can be made in some embodiments on the block chain network such as Ethereum or Bitcoin. Future value of such segments could vary widely depending on the scarcity or abundance of the segment available from Users that have recorded the segment. If the segment has been authenticated on the block chain the value may be even higher. The availability of Sources in a particular context or location at a particular time (an event) will vary. For example if an event occurs where there are many Sources that will be greater redundancy in the available local information. On the other hand a scarcity of Sources at the event reduces such redundancy. Therefore, the Shannon entropy of the communications from Sources will vary depending on such scarcity or abundance of local availability of Sources. Rare Sources may have a higher value in the event coverage is important to many Users or even of high-value to a single User.

Recognizing that while the Source to User two way communication for a segment is easily achieved, when there are multiple Users, two-way interaction between the Source and the User will be more difficult. When there is a single User in a two-way interaction with the Source the reverse voice channel segment from the User to the Source can also be part of the transaction on the block chain if the block chain is activated in some embodiments. In the multiple User case text may be used on the screens of the Users interface capturing the reverse channels from Users to the Source. As this is a part of the video record that do can be captured on the block chain in some embodiments. Alternatively, a conventional video conference architecture can be used with a star configuration of connections of bilateral interactions. See FIG. 37 where Source (i) and User (i) are interfaces of the same person. A similar architecture can be used for (2 way) telephone calls and teleconferences.

In addition to the above structures, for authentication of telephone calls and videoconferences that uses the same block chain mechanism for authentication of dialogue between 2 or more participants in a call. In the case of a videoconference transaction objects, in addition to the multiple checksums/hashes of peer to peer segments, a checksum/hash of a composite video transfer may be used to authenticate the bundle of communications, if individual videos are combined and transferred to each of the participants in a star configuration. Such a bundle can also be tokenized for an authentic record of a conference or call. This is an alternative to the architecture as noted above where each linkage between pairs of participants are in some embodiments tokenized with a digital signature and transferred a shown in FIG. 37.

The block chain will constitute multiple transactions and in aggregate these transactions may include multiple segments from Sources to Users in the local space of an event of interest ex-post. The block chain will therefore offer a mechanism for authentication of “truth media” by using multiple perspectives of the available sources. Some embodiments will have smart contracts in the block chain (eg Ethereum) that search for locations in available transactions, identify sets of segments between Sources and Users, identified the Users that own the segments (They may have paid a non-zero price for the segments to the Source), and negotiate with each of the Users (the Source may also be a User) for their Ask price for access to their segment These will then be combined and presented to the requester who may also be on the block chain as a User. The requester may then choose one or more of the Source segments. Notably, if there are multiple Users with the same Source the value of segments from any one of those Users will be eroded (Shannon Entropy). Some embodiments will include in the smart contract the redundancy information on every Source segment in the possession of the Users, so that the User may use this information to recognize the redundancy in his/her Ask price. In some embodiments, the requester will pay for the “gas” or cost for the smart contract. The use of tokens by users/viewers received from the sources can be in some embodiments a license for viewing but not for further dissemination. This could be stipulated in the smart contracts. The source may then be able to sell multiple copies of the same token/video clip to multiple users.

Token/video clips may also be saved by the source and released at a later date as historical record. These again can be paid for by users/viewers using in some instances smart contracts.

FIG. 35 shows the timelines for recorded media.

Here source 1 streams are represented by S110 to S1tF, for times to totF. Similarly, source 2streams are represented by S2m to S21F.

However, User/viewer 1, begins to capture the stream from source S1 at some time U110 (S1), with the parameters of S1 at that time recorded. Moreover, user 1 terminates the stream from source 1, at U11F (S1), and immediately commences viewing the stream from source 2 at U110 (S2), where U110 (S2)=U110 (S2). The user/viewer 1 continues to view the stream from source S2 until U11F (S2), which may be before source S2 terminates streaming.

The cryptographic representation of the streams of both S1 and S2 with their digital signatures are created in one embodiment of the invention, and are available for checking the authenticity of copies of these complete video streams.

Similarly, cryptographic representation of the received streams to U1 of each of the constituent streams from S1 and S2, In this embodiment their digital signatures created, for future reference to copies which may be checked by the instant invention for their authenticity.

In this embodiment there is no possibility of verifying that segments of streams from sources S1, S2 are the same as the streams from these two sources received by user U1.

However, if the stream received by user U1 is then reviewed by others and a copy needs to be authenticated that is possible relative to the stream U1 from both S1 and S2.

Another embodiment that allows authentication of streams directly from the sources is described below.

FIG. 36 shows another embodiment of the invention that modularizes each of the source streams S1 and S2, to fixed time length units, and records their cryptographic representation as a digital signature. Therefore, each of the streams have a sequence of digital signatures for each 10 second interval. The time of each interval of 10 seconds is used only as an example, and any suitable timeframe can be used for the units of the modular structure of each of the sources. However, in this embodiment the plurality of source streams have modules of 10 seconds that are synchronous. Therefore, the beginning and end of each 10 second module coincides for all the streams in the network. In this embodiment, the user's receive the streams from the sources e.g. S1 and S2. Therefore, they receive one or more of the 10 second modules which must have the same cryptographic representation. There may be a short period of less than 10 seconds where the user U1 is receiving a stream ahead of synchronized beginning of the next streamed 10 second module. Moreover, the user U1 may terminate his/her reception of the source ahead of the end of the then current 10 second module. With the exception of these periods both before the commencement of the first complete 10 second module that is received and after the last complete 10 second module until termination of the stream, on the other 10 second module digital signatures must be identical to the of the respective sources. Therefore, this embodiment, while it does not capture the digital signatures of the leading few seconds before the first and second module and that of the period Trailing the last 10 second module, has a unique property that the user U1 stream inputs have the same digital signatures as the sources. Moreover, this is true for a sequence of sources that are streamed by the user U1, when each of the streams have the digital signatures of each of the modules of the plurality of streams.

In this embodiment, itis possible to trace back the digital signatures of the modules received by the user to the digital signatures of those streamed by the source. This is in addition to, these two references being used to verify purported copies of the video streams of the user with the cryptographic digital signatures. In some embodiments, the digital signatures of each of the clips tokenizes the clips as assets that can be traded. The source would be the issuer of the tokens, and they will be registered in the wallet of the source. Thereafter, they are tradable. For example, in some embodiments streaming of the clip to a user could require a payment from the user to the source. Such embodiments, can use smart contracts to execute the financial transaction at the time the tokenized clip is transferred from the source to the user. Moreover, such a payment could be for what is effectively a license for use by the user, and may restrict further distribution by the user in some embodiments.

### The Transaction Structure—Element of Block in Block Chain

There are many elements that can be inserted as transactions into each block. These can include the actual times of commencement and end of a stream received by user. They can also include the digital signatures and the identifying source and viewer IOs and the start time of the module. There can be many of these modules and therefore many of these transactions for a single streaming session.

Transacf10n e ement examp es:

Source ID
Viewer ID
Stream Commencement time
Stream End Time
Stream Digital Signature -Video

Source ID
Viewer ID
Synchronous start time
Module Digital Signature -Video

Source ID
Viewer ID
Synchronous start time
Module Digital Signature -return
Voice channel

The structure of the video stream may have included in its metadata the location of the source. This will of course be part of the data that will be represented by the cryptographic digital signature. In an alternative embodiment the location information at each point in time (at any time interval but most conveniently at the beginning of each module) may be separately provided as a data point in the transaction structure. In one such case, we have the related transaction as:

Source ID
Viewer ID
Latitude
Longitude
Elevation
Synchronous start time
Module Digital Signature

Other examples of such additional information which may be separately inserted into the transaction or made a part of the metadata of the video stream are for example the facing direction of the camera, the field of view and other parameters related to the camera.

In constructing the block from such transactions, we will have multiple transactions as above, a block number, a nonce in the hash of the previous block. All this will be hashed to represent the instant block. In other embodiments the video file in it's raw form will be directly used rather than it's digital signature as noted above as an element of the transaction and in turn of the block to be hashed.

FIG. 38 is an embodiment of the Block in the Block chains. Notably there can be many types of transactions of which one is shown.

FIG. 37, shows the application in a multi-participant videoconference. Here, each of the sources stream their videos to each of the other parties and each of the streams will be cryptographically signed and available for the users for verification of their recordings.

In applications where the sources are distinct from the users the same process would apply but there will be fewer interconnections and necessary videos for cryptographic verification.

In some embodiments, the source streams are maintained as recordings, and pointers on those source recordings at the times of commencement and ending of user access to those recordings are maintained as pointers (See FIG. 39). Therefore, in such embodiments, the source recording is split into modules as before in some of the prior embodiments, and each of those modules is hashed to get a digital signature which can serve as a token. In the event of the source activating the cryptographic/block chain feature at the time of commencement of the stream by the source, in some embodiments the modules will begin at the time of commencement of the source stream, and successive modules will commence at fixed time periods after that commencement. The start time of the source recording is of course recorded, so that the commencement time of each module is known. Each of the clips are in this embodiment hashed and stored for use in assembling the blocks for subsequent admission to the block chain.

In some situations however, the source may not activate the block chain/cryptographic feature. In such an instance, the user is enabled to activate this feature and commence the modularization of the source stream recording from the time of the commencement of the stream to the first user. In terms of storage of the source recording while the entire source recording may be retroactively divided into modules and hashed and stored as separate modules, other embodiments will split the source recording into two parts, the first being up to the commencement of the first user sharing time, and the remainder of the source stream recording which is split into modules and hashed for inclusion into blocks immediately upon the availability. In some instances the Source may not even record the stream ahead of the first User request for cryptographic verification. In such instances there is no record of course ahead of the first request for the cryptographic record by a user. In these embodiments, the user commencement time pointer and the ending time pointer are maintained in the records, such that the modules required to reconstruct any one of the user streams will be known. In some instances, where the commencement of the first module of the source was at the time of commencement of the source stream, there may not be in alignment in time of the commencement of any one of the user streams and the start/end of modules. Therefore two possible embodiments are possible, where the users stream is augmented to include the sections of the stream that either precede or follow the user stream to bring it in line with the module termination times. In this embodiment, the user will have slightly more information than what was actually transmitted to that user. In an alternative embodiment, the module endpoints closes to the start and the end of the users stream, and lying within the user stream are used as the endpoints for the collection of modules representing the users stream, and used for hashing and as input for the blocks in the Block chains.

Some embodiments of the system do not have a facility for downloading the streams to the user, but rather allow access to the user for viewing their recordings within the system. Other embodiments, allow the user to download the streams that they have selected and watched. In such embodiments, they will be presented with the modules and their respective hashes, or in other embodiments, users are represented with their entire recordings, with additional information on the commencement of each module, the module duration, and the hashes for each of the modules. This will enable the user to reconstruct precisely the clips that constitute each of the modules and their respective hashes. In both these embodiments the user will have access to the hashes of each of the modules and the contents of the modules and can therefore use these tokenized modules for trading value with these downloaded streams.

In other embodiments where such downloads are possible, each of the segments of the stream provided by the source to each one of the users, can be in their entirety be hashed and become tokenized. However this is far less efficient as some segments of the source recording will have multiple users but in this instance, each of those instances will need to have a separate hash which is more computationally intensive. Moreover, the time of availability of the entire user stream recording will delay the time when it's hash can be inserted into a transaction into a block and entered into the block chain.

While most embodiments may use a common clock for calibrating the time of commencement of each video clip and the duration of the clips, other embodiments will have non-standard times for each source and even non-standard module time lengths for each Source. However, in such embodiments, this additional non-standard information must be recorded in the transaction. However, this complicates the level of information that needs to be transferred on the block chain, and may not be the preferred option.

### Using Source Video to Authenticate Suspect Third Party Video.

If the suspect video is from the same source as what is available in the network, the process of verification or authentication would be simply checking the tokens are digital signatures of the available source video clips alongside that of the suspect video. However, the suspect video may be from a different perspective to what is available in the source video clips. In such instances there are several possibilities as previously disclosed by the inventor, where the source light fields are created from the source video, to create a parent light fields from all available sources in the neighborhood, and using the elements of the parent light field the perspective of the suspect video can be constructed and checked for authenticity. Some embodiments could use AI techniques from the deconstructed light fields to generate new views or construct the 3D models of the neighborhood as a time sequence as the video progresses. Such 3D models can also be constructed as previously disclosed from a plurality of frames from multiple perspectives i.e. from multiple sources such models can then be used to refute suspect video.

The instant invention can be used for a broad range of evidence that was collected at a place and a time or a particular context and the time for future authentication and use. This can be for example a video that was captured at a particular place at a particular time which is authenticated with regard to such attributes.

It can also be written evidence that was collected and known at a particular time, and that may be represented by one or more characteristics such as fields, keywords etc., or in fact images which were composed at a particular location and time, or context and time.

The preferred embodiment that will be described in detail will be the invention used for video evidence. The same principles are extendable to the other classes of evidence or information in other embodiments.

Such authentication is provided in this invention, where the block chain such as Ethereum, is used to embed a transaction at a particular time in a block so that that time is authenticated and unchangeable in the block chain.

The preferred embodiment therefore uses video data by a video network. Considering the spatial nature of video information retrieval of such information can be with the use of spatial “Maps” for easy contextual search, where he location anywhere on the planet (and in the future other planets) can be located and zoomed into to find exact locations where useful information may reside at a particular time. This is done with for example the use of the “Time Machine map” which is part of this invention, where the user identifies a particular time range or date range, and uses the “radar” to identify the location where he/she would like to get data. The network provides icons in that area of the Radar, where such archival material is available. The user can select one of the icons to access the video data and receive an access NFT for that video data.

There are several business models in embodiments of the invention. Some embodiments of the video network will have an ownership NFT minted to the wallet of the source of the video. Such videos may be stored by the source for future review. They can also be used by other users on the network for simply viewing the videos with information about location and time of generation of the videos. The third possibility is for users to seek evidence at a particular location and time with her willingness to pay for authentication that the evidence was created at that place and time. Each of these have different kinds of access NFT tokens. Such NFT tokens are priced differently depending on demand. They may be for us fixed prices set by the sources or the video network (Wiink!) Or using a bid ask negotiation process to define the clearing price depending on the demand and supply of that particular NFT token where there is a limited supply to be sold.

“A” NFTs. Are the simplest form of NFTs rather source retrieves information from his/her own archives. Such retrieval may have a price in some instances and may have different prices for retrieval and for downloads.

When there is a demand for the videos that are available in the video network from others besides the source there are multiple possible business models and related embodiments.

In the video network archives that could be some videos that may include date and time metadata, whereas others may in addition have block chain representation of the creation of such video assets on the video network. Each of these can be accessed in multiple ways in different embodiments.

For example a “B”NFT can be granted to users that simply buy a video asset that's available without any block chain representation. This can be for a price for viewing, and can also be a different price in some embodiments for downloads.

If on the other hand there is a video asset that's available on the video network that has both metadata representing location and time butin addition has the block chain representation to be able to authenticate the location and time.

There are multiple ways in which such video assets can be accessed and paid for. For example in one model a BNFT can be sold to those who buy the video asset license with its metadata, but not the authentication using the block chain. In this model, a second payment for a “C” NFT is possible for purchasing the block chain authentication. In this situation the user will be already aware of the available video asset at a particular time and place before the block chain authentication is paid for and transferred to the user.

A second model, the B NFT is integrated into the “C”NFT and the asset/video is available only as a part of the blockchain authenticated version with the “C”NFT or not at all.

In this model and related embodiments, which are arguably the strongest in terms of economic value to the Video network and the Source, there is no prior disclosure of the asset before a decision by the user to purchase the “C”NFT.

### Creating the Metadata for Blockchain

This can be structured using a web resource such as OPENSEA. 10. The metadata is public and can be used to characterize the target asset. In many instances, the asset (for example an image or a video) is stored at the URL that is defined in open sea. All this information is stored in a Jason file with multiple fields representing the elements of the metadata, and a field representing the location of the asset.

A first class of embodiments of this invention can have the video/image url q> directly pointed to (usually as a hashμ—in some embodiments the IPFS CID) the IPFS or other indelible storage location. (Filebase is a useful web resource access IPFS and get the hash representation of the URLs.)

A second more important class of embodiments of the invention, will not disclose the evidence/video/image asset location q> or for that matter the IPFS CID u in the public domain. Instead the encrypted version U encrypted of the representative hash u of the IPFS location q> of the evidence/video/image asset will be available in the public domain in such a web resource.

In this second class, users will be able to search the block chain for any of the metadata elements, but will not be able to get to the address hash u of the evidence/video/image asset as that would be encrypted. All that will be available will be the μ_{encrypted}. This will need to be decrypted using a private key controlled by the video network (Wiink!).

This class of embodiments offers to the public a characterization of the asset through the block chain, so that they can search for their target assets and if such assets are available, they will know that access is possible through the video network/Wiink! for a price.

The decryption process will be where a smart contract or similar process, will take as input the encrypted address hash μ_{encrypted}, from the JSON file characterization (see below), and one or more private keys controlled by the video network (Wiink!), generate the decrypted hash u, and send this hash that represents the URL in the IPFS system, to retrieve the evidence/video/image asset stored in the IPF system, and disclose to the user the evidence/video/image asset but not its IPSF URL location, or its decrypted hash μ.

Such a smart contract or similar process may use in addition in some embodiments, well-known techniques in zero knowledge proof systems (ZKPS) such as ZK-STARK and ZK-SNARK each of which have their own benefits and shortcomings. Such techniques will provide the proof that the visible encrypted hash μ_{encrypted} that may be viewed by the user, along with an unseen private key provided by the evidence/video network, resulted in the private and undisclosed URL address to retrieve the disclosed asset that is delivered to the user.

Example of JSON file in IPFS storing the information of the video asset (note here there is only the encrypted version of the URL hash available.

```
{
  “description”: “Video Wiink!
  network”, “external_url”:
  “https://https://alchemy.com”,
  “video”: “https://ipfs.[encrypted(hash) of the
  hash (CID) of the url for the
  video asset]”, “name”: “xxxx”,
  “attributes”: [
{
      “trait_type ”:
      “Time”
      “value”:
      “21:16:23.7”
    },
    {
      “trait_type”:
      “Date_{†}”
      “value”:
      “2021-06-23”
    },
    {
      “trait_type”:
      “Geo 1”,
      “value”: xxxx
    },
    {
      “trait_type”:
      “Geo 2”,
      “value”: xxxx
    },
    {
      “trait_type”:
      “Geo 3”,
      “value”: xxxx
    },
    {
      “trait_type”:
      “Geo 4”,
      “value”:
      “xxxx^{‡}
    },
    {
      “trait_type”:
      “Geo 5”,
      “value”:
      “xxxx^{‡}
    },
    {
      “trait_type”:
      “Geo 6‘^{†}’
      “value”:
      “xxxx”
    },
    {
      “trait_type ^{‡}
      “Metadata 1_{†}”
      “value”: “xxxx”
    },
    {
      “trait_type ^{‡}
      “Metadata 2_{†}”
      “value”: “xxxx”
    },
    {
      “trait_type ^{‡}
      “Metadata 3_{†}”
      “value”: “xxxx”
    },
]
}
```

The use of private keys for encryption can take many forms in other embodiments of the invention.

There can be for example multiple private keys controlled by coalitions with in the Video network. The key role is to keep the actual address of the asset private.

The encrypted representation use of the address can also have a verification signature using the source, for later decryption and verification of source by the user who at the time of purchase of the license NFT, is endowed with the public key of the source.

Metadata to varying extents can be added to the transaction. In some embodiments, for reduced load on the main chain, various techniques to create secondary chains well-known in the background are can be employed. In some such embodiments, the specific transaction information may only be maintained for example in the full nodes.

At the time of creation of the video, the source public key in some embodiments will be transferred to the network, and maintain in the network for later use.

Some embodiments may also have the availability of a signature of the asset represented by hash. This can be a concise representation that can be used for comparison to fake representations of the “same” or similar videos.

In FIG. 42, other embodiments may have a ask price quoted and the user is invited to offer a bid price. Here, a market clearing algorithm will select the best licensee option if licenses are to be restricted. In some embodiments there is no issue of an NFT at all but in traditional fashion, simply provide the asset with an access license.

In FIG. 43, video available for viewing and in some embodiments downloading. Some embodiments have watermark on video and have a second priced phase where the user can pay additional fee for downloading the video.

In FIG. 26-006 the “C” NFT has attributes of the “B” NFT but in addition includes the right to query for block position and verify the asset at that block position. In some embodiments, asset saved location as referenced on the block transaction is encrypted and is accessed with private keys and therefore such verification is not available to the public who have access to the block chain information alone.

Some of such embodiments may use the private key of one or more custodians of the video network and/or the private key of the Source that generated the data. The encryption in some embodiments will be with the Source Private key and Network Admin Public key.

In FIG. 45, 46, there is a cost of verification. This can be priced as a single charge per user as a persistent access C NFT, or priced on a per verification basis or repurchase of a “C” NFT as a per use access NFT.

In FIG. 47, Video (or image or evidence documents or other asset) are saved in the indelible storage facility such as IPFS. Itis assigned a URL cp in the IPFS system. An IPFS CID hashμ is made available for reference to the IPFS URL address for access to the asset such as the video. This hash μ is Encrypted using the Source Private key and the Video Network Public key to create the encrypted CID hash μencrypted.

μencrypted is on the transaction record. The Video Network Private Key will be needed for decryption later. In addition Meta data such as location, time and other parameters of the record may be included.

In addition in some embodiments, a Signature for verification of the creating Source of the video or evidence is constructed with the Source Private Key and encrypted.

The Source Public Key is also made available to the Video Network eg Wiink!.

In FIG. 48, shows the information flows when the “C” NFT is purchased.

First, the μencrypted is decrypted using the Video Network eg Wiink! Private key. This may be in some embodiments be done in a Video Network Server to maintain confidentiality of μ. The Internal Video Network Server queries IPFS to get the Asset such as the video and Serves that content to the User. The Block information is also available to the User as this is public information but in addition it may be curated by the Video Network Server to present in formation in a better format.

In addition in some embodiments, there is a Signature Verification that can be activated with the Source Public Key that is maintained by the Video Network/Wink! and made available to the purchaser of the “C” NFT, to verify that the μ_{encrypted} did in fact come from the Source.

Considering that the time and location (in the case of evidence not location but characterizing key words) are on the block chain, Users can find the information directly on the block chain.

In FIG. 49, in some embodiments, ZKP (Zero Knowledge proof techniques well known in the background art are used to demonstrate to the user that the video served up by the Video Network/Wiink! server is in fact the video stored at the address cp in IPFS, and the was derived from the CID μ, which was decrypted from μ_{encrypted}, without revealing cp, or u to the buyer of the “C” NFT. Some examples of possible ZKP systems are ZK-STARKs and ZK-SNARKS.

FIG. 50, shows additional encryption of the final evidence or video asset that is made available to the “C” NFT purchaser for addition security. The Video Network Server will require the Public key of the “C” NFT purchaser to make this possible.

### Conclusions, Ramifications & Scope

It will become apparent that the present invention presented, provides a new paradigm for implementing key safety features comfort and convenience features for occupants in vehicle. It will become apparent that the present invention provides a structure using the block chain to authenticate evidence. This includes video evidence at specific locations that constitute events and also documentary evidence which may be in specific fields of use but also have creation dates which are embedded in the block chain.

Drawings Concordance with PCT Application Numbering
Drawings have been Renumbered to Meet USPTO Requirements

| PCT FIG. Number | USPTO FIG. Number |
|---|---|
| 23-1 | 1 |
| 23-2 | 2 |
| 23-3 | 3 |
| 23-4 | 4 |
| 23-5 | 5 |
| 23-6 | 6 |
| 23-7 | 7 |
| 23-8 | 8 |
| 23-9 | 9 |
| 23-10 | 10 |
| 23-11 | 11 |
| 23-12 | 12 |
| 23-13 | 13 |
| 23-14 | 14 |
| 23-15 | 15 |
| 23-16 | 16 |
| 23-17 | 17 |
| 23-18 | 18 |
| 23-19 | 19 |
| 24-01 | 20 |
| 24-02 | 21 |
| 24-03 | 22 |
| 24-04 | 23 |
| 24-05 | 24 |
| 24-06 | 25 |
| 24-07 | 26 |
| 24-08 | 27 |
| 24-09 | 28 |
| 24-10 | 29 |
| 24-11 | 30 |
| 24-12 | 31 |
| 24-13 | 32 |
| 24-14 | 33 |
| 24-15 | 34 |
| 25-01 | 35 |
| 25-02 | 36 |
| 25-03 | 37 |
| 25-04 | 38 |
| 25-05 | 39 |
| 26-001 | 40 |
| 26-002 | 41 |
| 26-003 | 42 |
| 26-004 | 43 |
| 26-005 | 44 |
| 26-006 | 45 |
| 26-007 | 46 |
| 26-008 | 47 |
| 26-009 | 48 |
| 26-010 | 49 |
| 26-011 | 50 |

1. (canceled)

2. (canceled)

3. (canceled)

4. (canceled)

5. (canceled)

6. Method for trading NFTs representing video or other evidence with purchaser knowledge a-priori of the location and time of the evidence but with the underlying NFT asset available for inspection only upon purchase.

7. Method for authenticating a video stream by:
Quantizing the stream into time segments of pre-determined size to create Quantized Clips;
Determining a summary measure of each of said Quantized Clips;
Attaching a time stamp and geo-location stamp to each of the Quantized Clips;
At the end time of each Quantized Clip, minting an NFT for each of the Quantized Clips by registering on the blockchain assigned to the wallet of the source
thereby registering the time of capture of the Quantized Clips.

8. A method as in claim 7, wherein said NFTs are tradable with Users.

9. A Method as in claim 7, wherein in trade with users:
Recognizing that each user may require a unique subset of the collection of Quantized Clips;
Trading a set of said Quantized Clips of the video stream to accommodate said subset of said Quantized Clips made available to users trading their respective NFTs;
thereby, trading the resulting NFTs.

10. A method for authenticating a plurality of concurrent video streams, each as in claim 7, wherein said plurality of video streams comprise a ensemble of video streams by:
Quantizing with common time slots, the elements of the ensemble of streams into time segments of pre-determined size to create Ensemble Sets of Quantized Clips;
Determining a summary measure of each of said Ensemble Sets of Quantized Clips;
Attaching a time stamp and geo-location stamp to each of the Ensemble Sets of Quantized Clips;
At the end time of each Ensemble Set of Quantized Clip, minting an NFT for each of the Quantized Clips by registering on the blockchain assigned to the wallet of the source
thereby registering the time of capture of each of the Ensemble Set of Quantized Clips.

11. A method for crowd sourced protection by trusted protectors in a community by:
Creating a social network with members of the community as members of the network;
Defining trust circles for each of the members of the network;
Constructing directional trust chain linkages from trusted member to beneficiary of the trust;
In the event of a need for protection for a threatened member of the community;
Enabling the threatened member to alert the network on a device interface wherein said device has a camera to record and stream voice and or video;
Building a first element of one or more trust chains from the threatened member as the beneficiary of trust to the first level trusted members;
Building a second element of each of said trust chains from the first level trust member to one or more second level trust members as trusted members;
Upon request from the threatened member, invoking signaling to one or more levels of trust members to construct a response team, to address the threat;
thereby relieving the threat.

12. A method for crowd sourced protection by trusted protector as in claim 11, wherein members of the response team are provided with at least one of: location information of the threatened member; and the video of the threatened member; and directions to progress towards the threatened member.
